(19) United States
(12) Patent Application Publication
(10) Pub. No.: US 2013/0028321 A1
(43) Pub. Date: Jan. 31, 2013

(54) APPARATUS AND METHOD FOR IMAGE PROCESSING

(71) Applicant: Kazushi Sato, Kanagawa (JP)

(72) Inventor: Kazushi Sato, Kanagawa (JP)

(73) Assignee: SONY CORPORATION, Tokyo (JP)

(21) Appl. No.: 13/638,944

(22) PCT Filed: Mar. 31, 2011
(86) PCT No.: PCT/JP11/58275

§ 371 Date: Oct. 2, 2012

(30) Foreign Application Priority Data
Apr. 9, 2010 (JP) 2010-090717

(51) Int. Cl. H04N 7/32

(52) U.S. Cl. 375/240.12; 375/E07.194

(57) ABSTRACT

The present invention relates to apparatuses and methods for image processing allowing for minimization of image degradation in a screen as a whole and improvement in local image degradation. An adaptive loop filter (111) is configured to classify per macroblock a decoded image from a deblocking filter (21) to classes associated with intra prediction mode information from a prediction mode buffer (112). The adaptive loop filter (111) is configured to calculate filter coefficients per the class in such a manner as to minimize residue between a source image from a screen sorting buffer (12) and an image from the deblocking filter (21). The adaptive loop filter (111) is configured to perform per the class filtering processing by use of the filter coefficients to be calculated, in such a manner that an image past the filtering processing is output to a frame memory (22). The present invention is applicable to an image coding apparatus for performing encoding based on, for example, H.264/AVC standard.

### TECHNICAL FIELD

The present invention relates to apparatuses and methods for image processing, and more particularly, to apparatuses and methods for image processing for minimizing image degradation in a screen as a whole as well as improving local image degradation.

### BACKGROUND ART

Recently, apparatuses are spreading which are configured to digitally handle image information while, in order to transmit and accumulate information with higher efficiency, compressing and encoding images by adopting a coding standard defining compression by means of an orthogonal transform, such as discrete cosine transform, and motion compensation with the use of redundancy unique to image information. Exemplary coding standards include MPEG (Moving Picture Experts Group).

MPEG-2 (ISO/IEC 13818-2) is specifically defined as a general-purpose image coding standard encompassing both interlace scan images and progressive scan images, as well as standard resolution images and high definition images. For example, MPEG-2 is currently in wide use for various applications for professional use and consumer use. By using MPEG-2 compression standard, an amount of coding (bitrate) of 4 to 8 Mbps is allocated to a standard resolution interlace scan image with, for example, 720×480 pixels. Further, by using MPEG-2 compression standard, for example, an amount of coding (bitrate) of 18 to 22 Mbps is allocated to a high resolution interlace scan image with, for example, 1920×1088 pixels. This enables achievement of higher compression rates and favorable image quality.

While MPEG-2 has been targeted for higher image encoding mainly adapted to broadcasting, this standard is not compatible with a coding standard involving an amount of encoding (bitrate) lower than MPEG-1, i.e., a higher compression rate. It is expected that the spread of mobile terminals will increase the need for such a coding standard from now, and in response to such a movement, standardization of MPEG-4 coding standard was carried out. As an image coding standard, ISO/IEC 14496-2 was agreed upon as an international standard in December, 1988.

In recent years, standardization of a standard referred to as H.26L (ITU-T Q6/16 VCEG) is under progress aiming for image coding, which was initially for video conference. While H.26L entails a larger amount of arithmetic operation in encoding and decoding as compared with a coding standard used heretofore, such as MPEG-2 and MPEG-4, it is known that higher coding efficiency is achievable. As a current activity related to MPEG-4, standardization is attempted as Joint Model of Enhanced-Compression Video Coding based on H.26L, so as to achieve higher coding efficiency with additional functions that are not supported by H.26L. The standardization is scheduled to be developed into an international standard as H.264 and MPEG-4 Part 10 in March, 2003 (Advanced Video Coding; hereinafter referred to as H.264/AVC).

FIG. 1 is a block diagram depicting a configuration example of an image coding apparatus configured to output compression images based on H.264/AVC.

In the example of FIG. 1, an image coding apparatus 1 includes an A/D converter 11, a screen sorting buffer 12, an arithmetic operator 13, an orthogonal transformer 14, a quantizer 15, a lossless encoder 16, an accumulation buffer 17, an inverse quantizer 18, an inverse orthogonal transformer 19, an arithmetic operator 20, a deblocking filter 21, a frame memory 22, a switch 23, an intra predictor 24, a motion predictor/compensator 25, a prediction image selector 26, and a rate controller 27.

The A/D converter 11 performs A/D conversion on input images for output to the screen sorting buffer 12 such that the converted images are stored thereon. The screen sorting buffer 12 sorts images of frames in the stored display order into an order of frames for encoding according to GOPs (Groups of Pictures).

The arithmetic operator 13 subtracts, from the images read from the screen sorting buffer 12, prediction images that have been output either from the intra predictor 24 or from the motion predictor/compensator 25 and been selected by the prediction image selector 26, so as to output the difference information to the orthogonal transformer 14. The orthogonal transformer 14 performs an orthogonal transform, such as discrete cosine transform or Karhunen-Loeve transform, on the difference information from the arithmetic operator 13 and outputs the transform coefficients. The quantizer 15 quantizes the transform coefficients output from the orthogonal transformer 14.

The quantized transform coefficients, which are the outputs from the quantizer 15, are input to the lossless encoder 16 so as to be subjected there to a lossless encoding such as variable length coding or binary arithmetic coding, for compression.

The lossless encoder 16 obtains information indicating intra prediction from the intra predictor 24 and obtains, for example, information indicating an inter prediction mode from the motion predictor/compensator 25. The information indicating intra prediction and the information indicating inter prediction are also referred to as “intra prediction mode information” and “inter prediction mode information,” respectively.

The lossless encoder 16 encodes the quantized transform coefficients as well as, for example, information indicating intra prediction and information indicating inter prediction mode and includes the encoded information into header information for compressed images. The lossless encoder 16 supplies the encoded data to the accumulation buffer 17 for accumulation.

For example, lossless encoding processing such as variable length coding or binary arithmetic coding is performed at the lossless encoder 16. Examples of the variable length coding include CAVLC (Context-Adaptive Variable Length Coding) defined by H.264/AVC standard. Examples of the binary arithmetic coding include CABAC (Context-Adaptive Binary Arithmetic Coding).

The accumulation buffer 17 outputs data supplied from the lossless encoder 16 to the decoding side, e.g., a recording apparatus or a channel at the later stage (not shown), as encoded compressed images encoded according to H.264/AVC standard.

The quantized transform coefficients output from the quantizer 15 are also input to the inverse quantizer 18 to be subjected to inverse quantization, followed by an inverse orthogonal transform at the inverse orthogonal transformer 19. The inverse orthogonal transformed outputs are added by the arithmetic operator 20 to prediction images to be supplied from the prediction image selector 26 so as to constitute a locally decoded image. The deblocking filter 21 removes block distortion in the decoded images to supply the images to the frame memory 22 for accumulation thereon. The frame memory 22 is also supplied with images that are yet to be subjected to deblocking filtering processing to be performed by the deblocking filter 21 for accumulation thereon.

The switch 23 outputs the reference images accumulated on the frame memory 22 to the motion predictor/compensator 25 or to the intra predictor 24.

In the image coding apparatus 1, for example, I pictures, B pictures, and P pictures from the screen sorting buffer 12 are supplied to the to the intra predictor 24 as images for intra prediction (also referred to as “intra processing.”) Further, B pictures and P pictures read from the screen sorting buffer 12 are supplied to the motion predictor/compensator 25 as images for inter prediction (also referred to as “inter processing.”)

The intra predictor 24 performs intra prediction processing in all candidate intra prediction modes based on the images to be subjected to intra prediction that are read from the screen sorting buffer 12 and the reference images supplied from the frame memory 22, so as to generate prediction images.

At this time, the intra predictor 24 calculates cost function values for all the candidate intra prediction modes and selects as an optimum intra prediction mode an intra prediction mode to which a minimum cost function value is given by the calculation.

The intra predictor 24 supplies the prediction images generated in the optimum intra prediction mode and the cost function values thereof to the prediction image selector 26. The intra predictor 24 supplies, in the case where a prediction image generated in the optimum intra prediction mode is selected by the prediction image selector 26, the information indicating the optimum intra prediction mode to the lossless encoder 16. The lossless encoder 16 encodes the information to include the information into header information for compressed images.

The motion predictor/compensator 25 is supplied with images to be subjected to inter processing that have been read from the screen sorting buffer 12, as well as reference images from the frame memory 22 through the switch 23. The motion predictor/compensator 25 performs motion prediction on blocks in all candidate inter prediction modes and generates motion vectors for the blocks.

The motion predictor/compensator 25 calculates cost function values for all the candidate inter prediction modes by using the predicted motion vectors for the blocks. The motion predictor/compensator 25 decides as an optimum inter prediction mode a prediction mode of a block that gives a minimum value of the calculated cost function values.

The motion predictor/compensator 25 supplies prediction images for target blocks in the decided optimum inter prediction mode and the cost function values thereof to the prediction image selector 26. The motion predictor/compensator 25 outputs information indicating the optimum inter prediction mode (inter prediction mode information) to the lossless encoder 16 in the case where a prediction image for a target block in the optimum inter prediction mode is selected by the prediction image selector 26.

At this time, information including motion vector information and reference frame information is also output to the lossless encoder 16. The lossless encoder 16 also performs lossless encoding processing such as variable length coding or binary arithmetic coding on the information from the motion predictor/compensator 25, so as to incorporate the information into the header portions of compressed images.

The prediction image selector 26 decides an optimum prediction mode from the optimum intra prediction mode and the optimum inter prediction mode based on the cost function values output from the intra predictor 24 or the motion predictor/compensator 25. Then, the prediction image selector 26 selects prediction images in the optimum prediction mode decided and supplies the images to the arithmetic operators 13 and 20. At this time, the prediction image selector 26 supplies to the intra predictor 24 or the motion predictor/compensator 25 the information on selection of prediction images.

The rate controller 27 controls the rate of the quantizing operation of the quantizer 15 based on the compressed images accumulated in the accumulation buffer 17 so as to protect from overflow or underflow.

FIG. 2 is a block diagram depicting a configuration example of an image decoding apparatus corresponding to the image coding apparatus of FIG. 1.

In the example of FIG. 2, an image decoding apparatus 31 includes an accumulation buffer 41, a lossless decoder 42, an inverse quantizer 43, an inverse orthogonal transformer 44, an arithmetic operator 45, a deblocking filter 46, a screen sorting buffer 47, a D/A converter 48, a frame memory 49, a switch 50, an intra predictor 51, a motion compensator 52, and a switch 53.

The accumulation buffer 41 accumulates compressed images that have been transmitted thereto. The lossless decoder 42 decodes the information that has been supplied from the accumulation buffer 41 and encoded by the lossless encoder 16 of FIG. 1 according to a standard corresponding to the coding standard adopted by the lossless encoder 16. The inverse quantizer 43 performs inverse quantization on the images decoded by the lossless decoder 42 according to a method corresponding to the quantization method adopted by the quantizer 15 of FIG. 1. The inverse orthogonal transformer 44 performs inverse orthogonal transform on the outputs from the inverse quantizer 43 according to a method corresponding to the orthogonal transform method adopted by the orthogonal transformer 14 of FIG. 1.

The inverse orthogonal transformed outputs are added by the arithmetic operator 45 to prediction images to be supplied from the switch 53 and are decoded. The deblocking filter 46 removes block distortion in the decoded images and then supplies the images to the frame memory 49 for accumulation, while outputting the images to the screen sorting buffer 47.

The screen sorting buffer 47 sorts images. More specifically, the order of the frames that has been sorted by the screen sorting buffer 12 of FIG. 1 into the encoding order is sorted into the original display order. The D/A converter 48 performs D/A conversion on the images supplied from the screen sorting buffer 47 and outputs the images to a display (not shown), so as for the images to be displayed thereon.

The switch 50 reads images to be subjected to inter processing and reference images from the frame memory 49 for output to the motion compensator 52, while reading images for use in intra prediction from the frame memory 49 for supply to the intra predictor 51.

The intra predictor 51 is supplied from the lossless decoder 42 with the information indicating an intra prediction mode that has been obtained by decoding header information. The intra predictor 51 generates prediction images based on this information and outputs the generated prediction images to the switch 53.

Of the pieces of information obtained by decoding header information, the motion compensator 52 is supplied from the lossless decoder 42 with information including inter prediction mode information, motion vector information, and reference frame information. The inter prediction mode information is received per macroblock. The motion vector information and the reference frame information are received per target block.

The motion compensator 52 generates pixel values of prediction images for target blocks by using motion vector information and reference frame information to be supplied from the lossless decoder 42 in a prediction mode indicated by inter prediction mode information to be supplied from the lossless decoder 42. The generated pixel values of the prediction images are output to the arithmetic operator 45 through the switch 53.

The switch 53 selects prediction images that have been generated by the motion compensator 52 or the intra predictor 51 and supplies the images to the arithmetic operator 45.

Further, as an extended activity for the H.264/AVC standard, standardization has been completed in February, 2005 as FRExt (Fidelity Range Extension) that encompasses coding tools for business use, such as RGB and 4:2:2 and 4:4:4, and 8×8 DCT and quantization matrices that are defined by MPEG-2. This fructifies into a coding standard achieving favorable rendering of even film noise contained in movies with the use of H.264/AVC, which is going to be used in a wide range of applications including Blu-Ray Disc (trademark).

Meanwhile, needs are growing nowadays for coding technologies allowing for higher compression rates which will, for example, enable compression of an image on the order of 4000×2000 pixels that are as four times finer as high definition images or distribution of high definition images in an environment where transmission capacity is limited, as over the Internet. For this reason, study is continuously conducted on improvement of coding efficiency at VCEG (=Video Coding Expert Group) which is a subgroup of the above-mentioned ITU-T.

As one approach for improvement in coding efficiency, a technique of Adaptive Loop Filter (ALF) is proposed in Non-patent Document 1.

FIG. 3 is a block diagram depicting a configuration example of an image coding apparatus to which the adaptive loop filter is applied. In the example of FIG. 3, the A/D converter 11, the screen sorting buffer 12, the accumulation buffer 17, the switch 23, the intra predictor 24, the prediction image selector 26, and the rate controller 27 of FIG. 1 are not shown for simplifying the description. For that purpose, some arrows are also not shown. Hence, in the case of the example of FIG. 3, reference images from the frame memory 22 are directly input to the motion predictor/compensator 25, and predictions images from the motion predictor/compensator 25 are directly output from the arithmetic operators 13 and 20.

More specifically, the image coding apparatus 61 of FIG. 3 is different from the image coding apparatus 1 of FIG. 1 in that an adaptive loop filter 71 is additionally provided between the deblocking filter 21 and the frame memory 22.

The adaptive loop filter 71 performs calculation of the coefficients of the adaptive loop filter so as to minimize the residue from source images from the screen sorting buffer 12 (not shown) and uses the adaptive loop filter coefficients to perform filtering on the decoded images from the deblocking filter 21. Examples of the filter include a Wiener Filter.

Further, the adaptive loop filter 71 sends the calculated adaptive loop filter coefficients to the lossless encoder 16. At the lossless encoder 16, the adaptive loop filter coefficients are processed with lossless encoding such as variable length coding or binary arithmetic coding to insert the result to header portions of compressed images.

FIG. 4 is a block diagram of a configuration example of an image decoding apparatus corresponding to the image coding apparatus of FIG. 3. In the example of FIG. 4, the accumulation buffer 41, the screen sorting buffer 47, the D/A converter 48, the switch 50, the intra predictor 51, and the switch 53 of FIG. 2 are not shown for simplifying the description. For the same purpose, arrows are not shown in some cases. Hence, in the case of the example of FIG. 4, reference images from the frame memory 49 are directly input to the motion compensator 52, and prediction images from the motion compensator 52 are directly output to the arithmetic operator 45.

More specifically, the image decoding apparatus 81 of FIG. 4 is different from the image decoding apparatus 31 of FIG. 2 in that the adaptive loop filter 91 is additionally provided between the deblocking filter 46 and the frame memory 49.

The adaptive loop filter 91 is supplied from the lossless decoder 42 with the adaptive loop filter coefficients that have been obtained by decoding and extracted from headers. The adaptive loop filter 91 uses the supplied filter coefficients to perform filtering processing on the decoded images from the deblocking filter 46. The examples of the filter include a Wiener Filter.

In this manner, the image quality of decoded images is improved and the image quality of reference images is also improved.

According to the H.264/AVC standard, the macroblock size is 16×16 pixels. Setting the macroblock size to 16×16 pixels however is not optimal for larger picture frames such as UHD (Ultra High Definition; 4000×2000 pixels) which can be an object of next-generation coding standards.

Thus, in documents such as Non-patent Document 2, proposal is made to extend the macroblock size to, for example, 32×32 pixels.

It is to be noted that Non-patent Document 2 proposes application of extended macroblocks to inter slices and Non-patent Document 3 proposes application of extended macroblocks to intra slices.

### CITATION LIST

### Non-Patent Document

Non-patent Document 1: Takeshi. Chujoh, et al., “Block-based Adaptive Loop Filter” ITU-T SG16 Q6 VCEG Contribution, AI18, Germany, July, 2008
Non-patent Document 2: “Video Coding Using Extended Block Sizes”, VCEG-AD09, ITU-Telecommunications Standardization Sector STUDY GROUP Question 16-Contribution 123, January 2009 Non-patent Document 3: “Intra Coding Using Extended Block Sizes”, VCEG-AL28, July 2009

### SUMMARY OF THE INVENTION

### Problems to be Solved by the Invention

According to the method proposed in Non-patent Document 1, distinction is not made between the flat region and the region containing texture and the Wiener filter is used so as to minimize the encoding degradation of the screen as a whole. Hence, improvement for local image degradation to be caused in the flat region and in the region containing texture has been on the agenda. Specifically, block distortion tends to occur in the flat region, and mosquito distortion tends to occur in the region containing an edge and/or texture.

The degree of difficulty for improving this kind of image degradation is noticeable in I slices.

The present invention was made in view of the foregoing circumstances and achieves minimization of image degradation of the screen as a whole as well as improvement in local image degradation.

### Solutions to Problems

An image processing apparatus according to one aspect of the present invention includes: a classifier configured to classify an image per specific block according to intra prediction mode information; and a filtering processor configured to perform filtering processing on the specific blocks to be classified by the classifier, by use of a filter coefficient to be calculated based on the specific blocks to be classified to the same class.

The classifier may be configured to classify an image per the block according to a prediction block size for the blocks in the intra prediction mode information.

The classifier may be configured to classify an image per the block according to a block size, the block size being the prediction block size for the blocks and defined by a coding standard.

The classifier may be configured to classify the blocks to be encoded in an intra 16×16 prediction mode as blocks included in a flat region.

The classifier may be configured to classify the blocks to be encoded in an intra prediction mode that has a smaller block size than the intra 16×16 prediction mode as blocks including an edge or texture.

The classifier may be configured to classify the blocks to be encoded in an intra prediction mode that has a larger block size than the intra 16×16 prediction mode as blocks included in a flat region.

The specific blocks include a plurality of subblocks, and the classifier may be configured to classify an image per the block or per the subblock according to a kind of prediction modes for the blocks or the subblocks of the same prediction block size in the intra-related prediction mode information.

The classifier may be configured to classify the blocks or the subblocks to be encoded in a vertical prediction mode and a horizontal prediction mode as the blocks or the subblocks including an edge or texture.

The classifier may be configured to classify the blocks or subblocks to be encoded in a prediction mode other than a vertical prediction mode and a horizontal prediction mode as the blocks or the subblocks included in a flat region.

A filter coefficient calculator configured to calculate the filter coefficient based on the specific blocks to be classified to the same class may be further included.

A transmitter configured to transmit bitstreams of the image, information indicating the intra prediction-related modes, and the filter coefficient to be calculated by the filter coefficient calculator may be further included.

A receiver configured to receive bitstreams of the image, information indicating the intra prediction-related modes, and the filter coefficient may be further included.

A method of processing images according to one aspect of the present invention, for use in an image processing apparatus including a classifier and a filtering processor, includes: classifying by the classifier an image per specific block according to intra prediction mode information; and performing by the filtering processor filtering processing on the classified specific blocks by using a filter coefficient calculated based on the specific blocks classified to the same class.

According to one aspect of the present invention, an image is classified per specific block according to intra prediction mode information, and filtering processing is performed on the classified specific blocks by using a filter coefficient calculated based on the specific blocks classified to the same class.

It is to be noted that the above-described image processing apparatuses may be discrete apparatuses or may be internal blocks configuring one image coding apparatus or image decoding apparatus.

### Effects of the Invention

The present invention achieves minimization of image degradation in a screen as a whole as well as improvement in local image degradation.

### BRIEF DESCRIPTION OF DRAWINGS

FIG. 1 is a block diagram depicting a configuration example of an image coding apparatus according to H.264/AVC standard.

FIG. 2 is a block diagram depicting a configuration example of an image decoding apparatus according to H.264/AVC standard.

FIG. 3 is a block diagram depicting a configuration example of an image coding apparatus to which an adaptive loop filter is applied.

FIG. 4 is a block diagram depicting a configuration example of an image decoding apparatus to which an adaptive loop filter is applied.

FIG. 5 is a block diagram depicting the configuration of one embodiment of an image coding apparatus to which the present invention is applied.

FIG. 6 is an explanatory diagram of a processing order in the case of an intra prediction mode for 16×16 pixels.

FIG. 7 depicts kinds of intra prediction modes for a luminance signal of 4×4 pixels.

FIG. 8 depicts the kinds of intra prediction modes of the luminance signal of 4×4 pixels.

FIG. 9 is an explanatory diagram of directions of the 4×4 pixel-intra prediction.

FIG. 10 is an explanatory diagram of the 4×4 pixel-intra prediction.

FIG. 11 is an explanatory diagram of encoding in an intra prediction mode for a luminance signal of 4×4 pixels.

FIG. 12 depicts kinds of intra prediction modes for a luminance signal of 8×8 pixels.

FIG. 13 depicts the kinds of intra prediction modes for the luminance signal of 8×8 pixels.

FIG. 14 depicts kinds of intra prediction modes for a luminance signal of 16×16 pixels.

FIG. 15 depicts the kinds of intra prediction modes for the luminance signal of 16×16 pixels.

FIG. 16 is an explanatory diagram of the 16×16 pixel-intra prediction.

FIG. 17 depicts kinds of intra prediction modes for a color difference signal.

FIG. 18 is an explanatory diagram of the operation principle of a deblocking filter.

FIG. 19 is an explanatory diagram of a method of defining Bs.

FIG. 20 is an explanatory diagram of the operation principle of a deblocking filter.

FIG. 21 depicts an example of numerical correlation between indexA and indexB and α and β.

FIG. 22 depicts an example of correlation between Bs and indexA and tC0.

FIG. 23 depicts exemplary macroblocks

FIG. 24 is a block diagram depicting a configuration example of the adaptive loop filter of FIG. 5.

FIG. 25 is a flowchart describing encoding processing of the image coding apparatus of FIG. 5.

FIG. 26 is a flowchart describing intra prediction processing in step S13 of FIG. 25.

FIG. 27 is a flowchart describing motion prediction/compensation processing in step S14 of FIG. 25.

FIG. 28 is a flowchart describing exemplary classification coefficient calculation processing in step S24 of FIG. 25.

FIG. 29 is a block diagram depicting the configuration of one embodiment of an image decoding apparatus to which the present invention is applied.

FIG. 30 is a block diagram depicting a configuration example of the adaptive loop filter of FIG. 29.

FIG. 31 is a flowchart describing decoding processing of the image decoding apparatus of FIG. 29.

FIG. 32 is a flowchart describing prediction image generation processing in step S133 of FIG. 31.

FIG. 33 is a flowchart describing classification filtering processing in step S140 of FIG. 31.

FIG. 34 is a block diagram depicting a configuration example of hardware of a computer.

FIG. 35 is a block diagram depicting a main configuration example of a television receiver to which the present invention is applied.

FIG. 36 is a block diagram depicting a main configuration example of a mobile phone to which the present invention is applied.

FIG. 37 is a block diagram depicting a main configuration example of a hard disk recorder to which the present invention is applied.

FIG. 38 is a block diagram depicting a main configuration example of a camera to which the present invention is applied.

### MODE FOR CARRYING OUT THE INVENTION

Embodiments of the present invention are described below with reference to the drawings.

### Configuration Example of Image Coding Apparatus

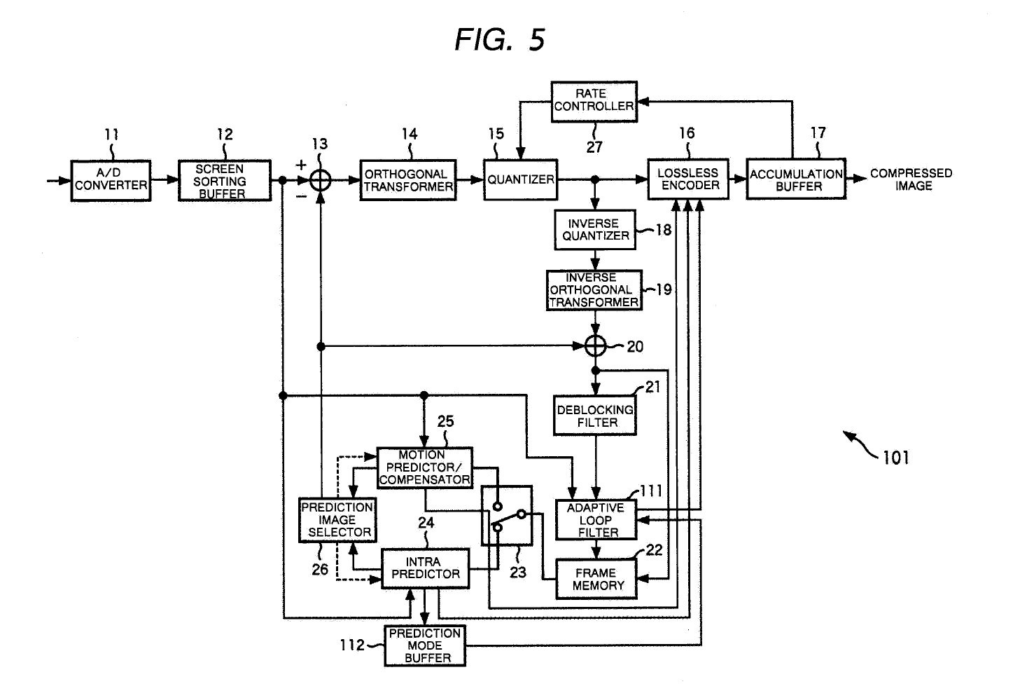

FIG. 5 describes the configuration of one embodiment of an image processing apparatus in the form of an image coding apparatus to which the present invention is applied.

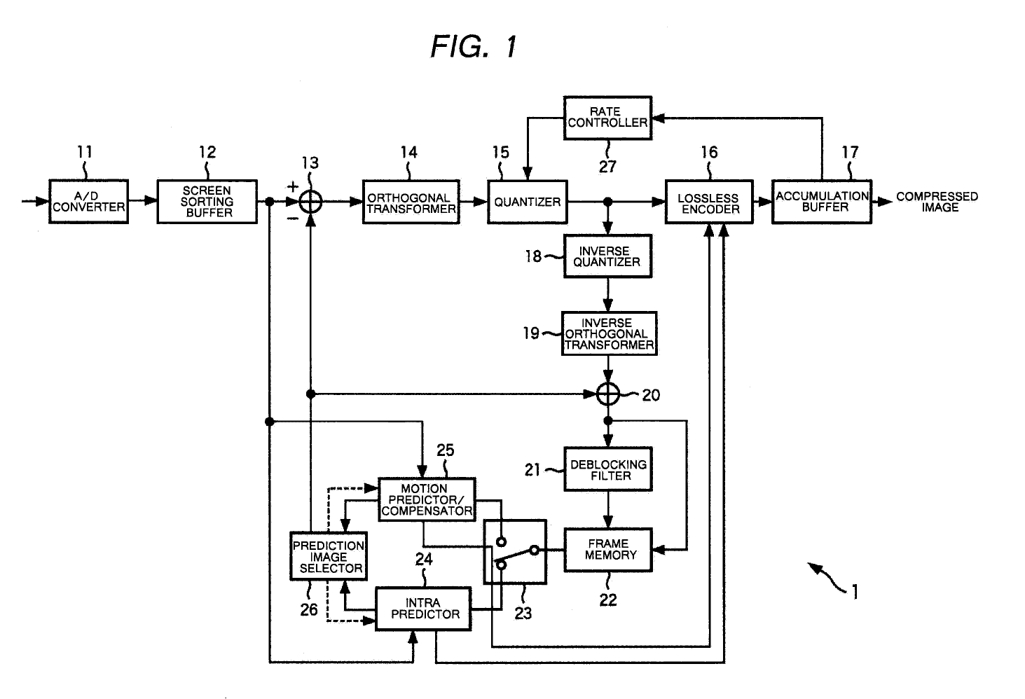

Like the image coding apparatus 1 of FIG. 1, an image coding apparatus 101 of FIG. 5 includes the A/D converter 11, the screen sorting buffer 12, the arithmetic operator 13, the orthogonal transformer 14, the quantizer 15, the lossless encoder 16, the accumulation buffer 17, the inverse quantizer 18, the inverse orthogonal transformer 19, the arithmetic operator 20, the deblocking filter 21, the frame memory 22, the switch 23, the intra predictor 24, the motion predictor/compensator 25, the prediction image selector 26, and the rate controller 27.

Unlike the image coding apparatus 1 of FIG. 1, the image coding apparatus 101 of FIG. 5 additionally includes an adaptive loop filter 111 and a prediction mode buffer 112.

Specifically, the adaptive loop filter 111 is provided at the back of the deblocking filter 21 and in front of the frame memory 22. More specifically, the adaptive loop filter 111 is provided in a motion compensation loop including the arithmetic operator 13, the orthogonal transformer 14, the quantizer 15, the inverse quantizer 18, the inverse orthogonal transformer 19, the arithmetic operator 20, the deblocking filter 21, the frame memory 22, the switch 23, the intra predictor 24 or the motion predictor/compensator 25, and the prediction image selector 26. That is, images for use loop in the motion compensation loop.

The adaptive loop filter 111 classifies, in the case where a decoded image from the deblocking filter 21 is an I picture, the image is classified into a class corresponding to the intra prediction mode information from the prediction mode buffer 112. The adaptive loop filter 111 calculates a filter coefficient in such a manner as to minimize the residue from a source image from the screen sorting buffer 12 and the image from the deblocking filter 21 according to the assigned class. The adaptive loop filter 111 uses the calculated filter coefficient to perform filtering processing according to the assigned class, so as to output a filtered image to the frame memory 22. Examples of the filter include a Wiener Filter.

In the case where the decoded image from the deblocking filter 21 is not an I picture, the adaptive loop filter 111 does not perform classification and calculates a filter coefficient by fully using the decoded image to perform filtering processing on the entire decoded image by using the calculation result.

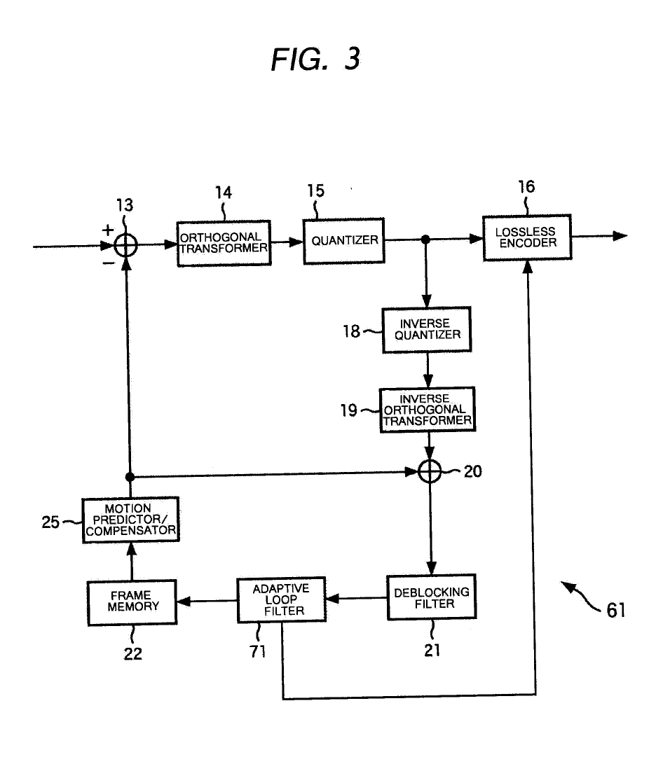

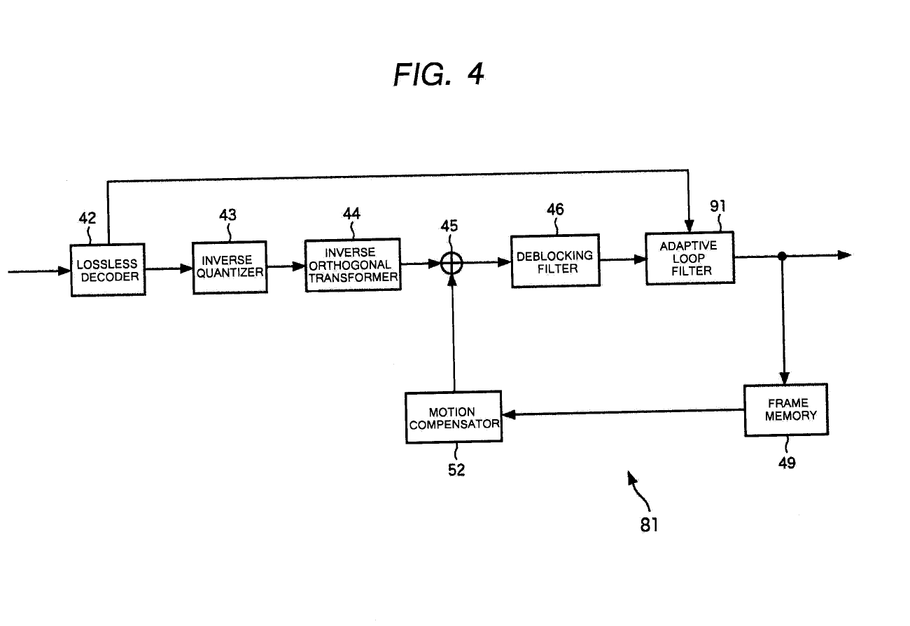

The adaptive loop filter 111 sends the calculated filter coefficient to the lossless encoder 16. At this time, the lossless encoder 16 encodes, as in the case of FIG. 3, the filter coefficient calculated by the adaptive loop filter 111 for insertion into the slice header portion of a compressed image or a picture parameter set.

The prediction mode buffer 112 stores intra prediction mode information decided by the intra predictor 24.

### Description of Intra Prediction Processing

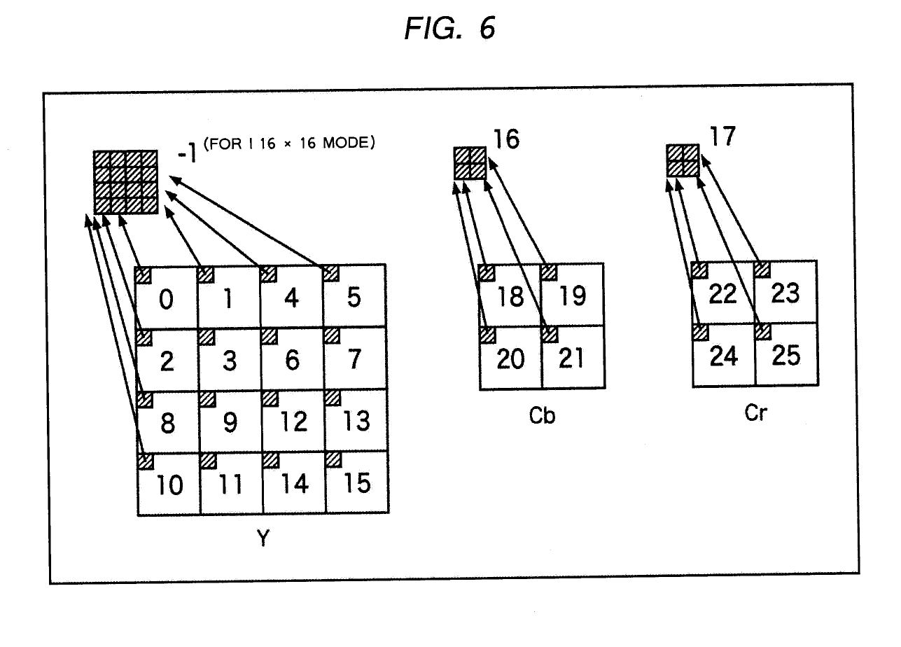

Description is given next in detail of the above-described processes. With reference to FIG. 6, the modes of intra prediction are described.

Intra prediction modes for the luminance signal are first described. Three standards, i.e., an intra 4×4 prediction mode, an intra 8×8 prediction mode, and an intra 16×16 prediction mode are set for the prediction block sizes defined according to the H.264/AVC coding standard for the intra prediction mode for the luminance signal. These modes define the unit of blocks and set per macroblock. Regarding the color difference signal, intra prediction modes may be set by macroblock independently of the modes for the luminance signal.

Prediction modes indicating a plurality of kinds of prediction methods are provided for the prediction block sizes. In the case of the intra 4×4 prediction mode, one prediction mode may be set out of nine kinds of prediction modes per target block of 4×4 pixels. In the case of the intra 8×8 prediction mode, one prediction mode may be set out of nine kinds of prediction modes per target block of 8×8 pixels. In the case of the intra 16×16 prediction mode, one prediction mode may be set out of four kinds of prediction modes per target macroblock of 16×16 pixels.

The intra 4×4 prediction mode, intra 8×8 prediction mode, and intra 16×16 prediction mode are also appropriately referred to as 4×4 pixel-intra prediction mode, 8×8 pixel-intra prediction mode, and 16×16 pixel-intra prediction mode, respectively.

In the example of FIG. 6, the numbers −1 to 25 assigned to the blocks indicate the bitstream order of the blocks (the order of processing on the decoding side). Regarding the luminance signal, macroblocks are divided into 4×4 pixels, such that DCT for 4×4 pixels is performed. In the intra 16×16 prediction mode, as indicated by the “−1” block, direct current components of the blocks are collected to form four by four matrices, and an orthogonal transform is perform on the matrices.

Meanwhile, regarding the color difference signal, macroblocks are divided into 4×4 pixels and DCT for 4×4 pixels is performed thereon; after that, as indicated by the “16” and “17” blocks, direct current components of the blocks are collected so as to form 2×2 matrices, such that an orthogonal transform is further performed on the matrices.

With respect to the intra 8×8 prediction mode, the above is applicable to the case in which an 8×8 orthogonal transform is perform on target macroblocks in a high profile or an even higher profile.

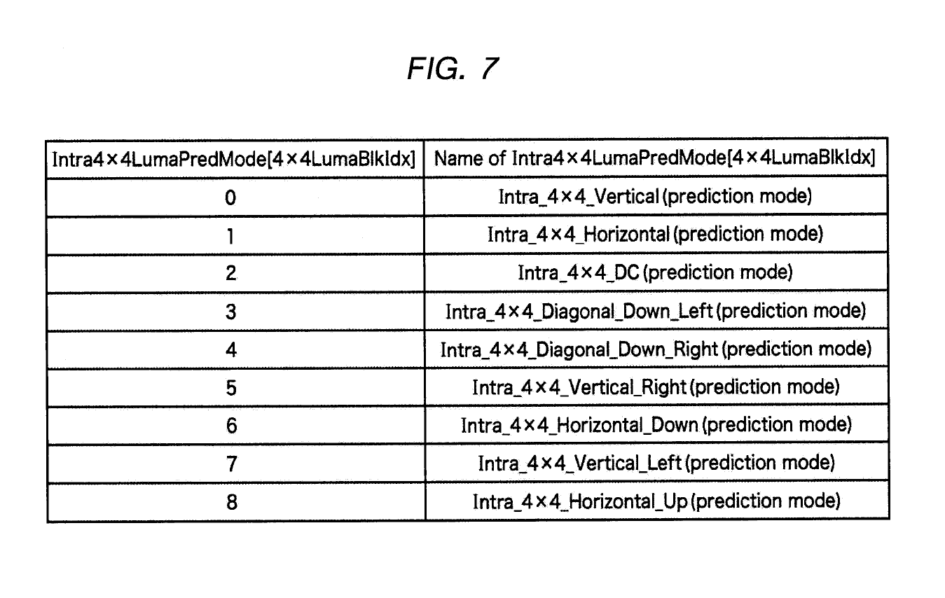

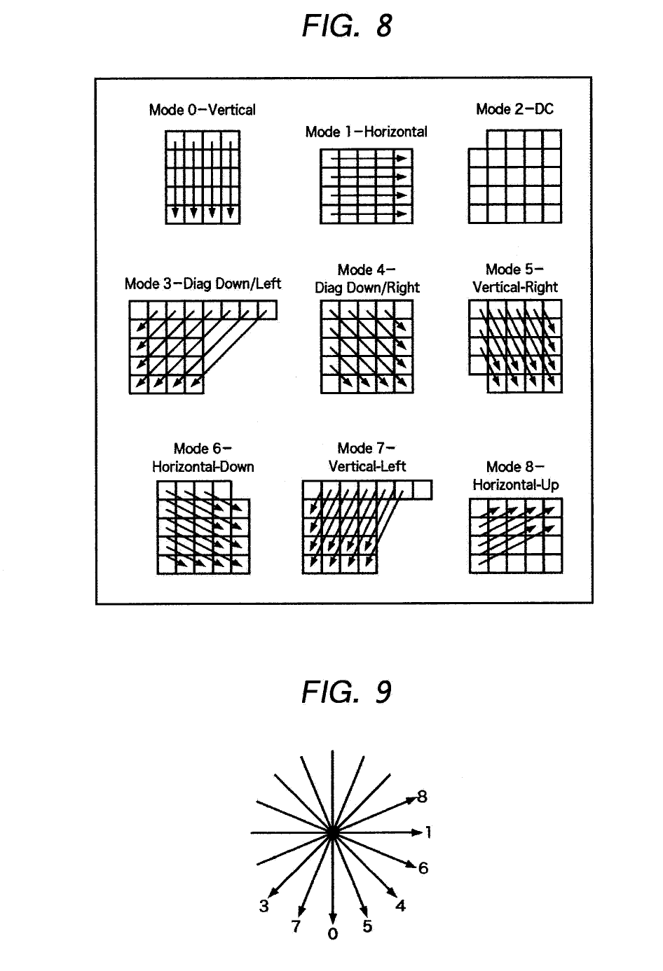

FIGS. 7 and 8 depict nine kinds of 4×4 pixel-intra prediction modes (Intra_{—}4×4_pred_mode) for the luminance signal. The eight kinds of modes other than Mode 2 indicating the mean (DC) prediction correspond to the directions indicated by the numbers 0, 1, and 3 to 8 of FIG. 9, respectively.

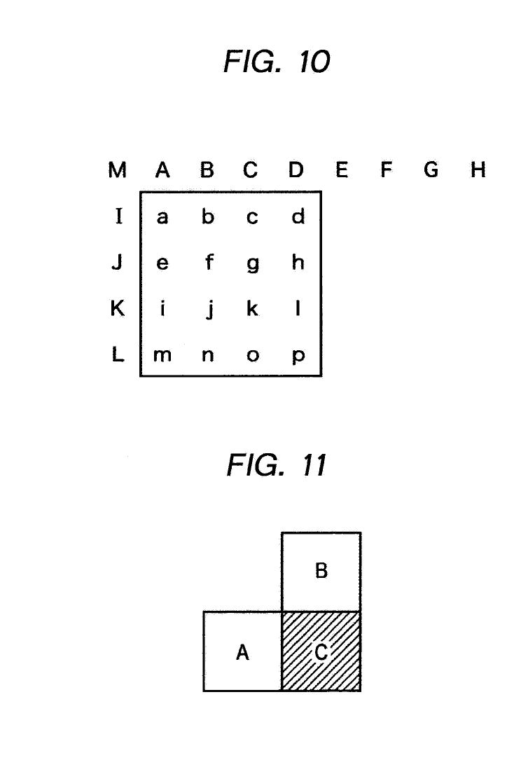

FIG. 10 is referenced to describe the nine kinds of Intra_{—}4×4_pred_modes. In the example of FIG. 10, pixels a to p indicate the pixels of target blocks to be subjected to the intra processing, and pixel values A to M indicate the values of pixels belonging to adjacent blocks. More specifically, pixels a to p are images to be processed that have been read from the screen sorting buffer 62, and pixel values A to M are the pixel values of decoded images to be referenced that have been read from the frame memory 72.

In the case of the intra prediction modes depicted in FIGS. 7 and 8, the prediction pixel values of the pixels a top are generated in the following manner by using the pixel values A to M of pixels belonging to adjacent blocks. It is to be noted that the description that pixel values are “available” means that the pixels are usable for non-existence of causes such as the pixels being present at an edge of a picture frame or being yet to be encoded. On the other hand, the description that pixel values are “unavailable” means that the pixels are not usable for a cause such as the pixels being at an edge of a picture frame or being yet to be encoded.

Mode 0 is a Vertical Prediction mode and is applicable to the case in which the pixel values A to D are “available”. In this case, the prediction pixel values of the pixels a to p are generated according to the following equations (1):

prediction pixel values of pixels a,e,i,m=A

prediction pixel values of pixels b,f,j,n=B

prediction pixel values of pixels c,g,k,o=C

prediction pixel values of pixels d,h,l,p=D (1)

Mode 1 is a Horizontal Prediction mode and is applicable to the case in which the pixel values I to L are “available”. In this case, the prediction pixel values of the pixels a to p are generated according to the following equations (2):

prediction pixel values of pixels a,b,c,d=I

prediction pixel values of pixels e,f,g,h=J

prediction pixel values of pixels i,j,k,l=K

prediction pixel values of pixels m,n,o,p=L (2)

Mode 2 is a DC Prediction mode, and the prediction pixel values are generated according to the following equation (3) where the pixel values A, B, C, D, I, J, K, and L are fully “available”:

(A+B+C+D+I+J+K+L+4)>>3 (3)

The prediction pixel values are generated according to the following equation (4) where the pixel values A, B, C, and D are fully “unavailable”:

(I+J+K+L+2)>>2 (4)

The prediction pixel values are generated according to the following equation (5) where the pixel values I, J, K, and L are fully “unavailable”:

(A+B+C+D+2)>>2 (5)

Where the pixel values A, B, C, D, I, J, K, and L are fully “unavailable”, 128 is used as the prediction pixel value.

Mode 3 is a Diagonal_Down_Left Prediction mode and is applicable to the case in which the pixel values A, B, C, D, I, J, K, L, and M are “available”. In this case, the prediction pixel values of pixels a to p are generated according to the equations (6):

prediction pixel values of pixel a=(A+2B+C+2)>>2

prediction pixel values of pixels b,e=(B+2C+D+2)>>2

prediction pixel values of pixels c,f,i=(C+2D+E+2)>>2

prediction pixel values of pixels d,g,j,m=(D+2E+F+2)>>2

prediction pixel values of pixels h,k,n=(E+2F+G+2)>>2

prediction pixel values of pixels l,o=(F+2G+H+2)>>2

prediction pixel values of pixel p=(G+3H+2)>>2 (6)

Mode 4 is a Diagonal_Down_Right Prediction mode and is applicable to the case in which the pixel values A, B, C, D, I, J, K, L, and M are “available”. In this case, the prediction pixel values of pixels a to p are generated according to the equations (7):

prediction pixel values of pixel m=(J+2K+L+2)>>2

prediction pixel values of pixels i,n=(I+2J+K+2)>>2

prediction pixel values of pixels e,j,o=(M+21+J+2)>>2

prediction pixel values of pixels a,f,k,p=(A+2M+I+2)>>2

prediction pixel values of pixels b,g,l=(M+2A+B+2)>>2

prediction pixel values of pixels c,h=(A+2B+C+2)>>2

prediction pixel values of pixel d=(B+2C+D+2)>>2 (7)

Mode 5 is a Diagonal_Vertical_Right Prediction mode and is applicable to the case in which the pixel values A, B, C, D, I, J, K, L, and M are “available”. In this case, the prediction pixel values of pixels a to p are generated according to the equations (8):

prediction pixel values of pixels a,j=(M+A+1)>>1

prediction pixel values of pixels b,k=(A+B+1)>>1

prediction pixel values of pixels c,l=(B+C+1)>>1

prediction pixel values of pixel d=(C+D+1)>>1

prediction pixel values of pixels e,n=(I+2M+A+2)>>2

prediction pixel values of pixels f,o=(M+2A+B+2)>>2

prediction pixel values of pixels g,p=(A+2B+C+2)>>2

prediction pixel values of pixel h=(B+2C+D+2)>>2

prediction pixel values of pixel i=(M+21+J+2)>>2

prediction pixel values of pixel m=(I+2J+K+2)>>2 (8)

Mode 6 is a Horizontal_Down Prediction mode and is applicable to the case in which the pixel values A, B, C, D, I, J, K, L, and M are “available”. In this case, the prediction pixel values of pixels a to p are generated according to the equations (9):

prediction pixel values of pixels a,g=(M+I+1)>>1

prediction pixel values of pixels b,h=(I+2M+A+2)>>2

prediction pixel values of pixel c=(M+2A+B+2)>>2

prediction pixel values of pixel d=(A+2B+C+2)>>2

prediction pixel values of pixels e,k=(I+J+1)>>1

prediction pixel values of pixels f,l=(M+21+J+2)>>2

prediction pixel values of pixels i,o=(J+K+1)>>1

prediction pixel values of pixels j,p=(I+2J+K+2)>>2

prediction pixel values of pixel m=(K+L+1)>>1

prediction pixel values of pixel n=(J+2K+L+2)>>2 (9)

Mode 7 is a Vertical_Left Prediction mode and is applicable to the case in which the pixel values A, B, C, D, I, J, K, L, and M are “available”. In this case, the prediction pixel values of pixels a to p are generated according to the equations (10):

prediction pixel values of pixel a=(A+B+1)>>1

prediction pixel values of pixels b,i=(B+C+1)>>1

prediction pixel values of pixels c,j=(C+D+1)>>1

prediction pixel values of pixels d,k=(D+E+1)>>1

prediction pixel values of pixel l=(E+F+1)>>1

prediction pixel values of pixel e=(A+2B+C+2)>>2

prediction pixel values of pixels f,m=(B+2C+D+2)>>2

prediction pixel values of pixels g,n=(C+2D+E+2)>>2

prediction pixel values of pixels h,o=(D+2E+F+2)>>2

prediction pixel values of pixel p=(E+2F+G+2)>>2 (10)

Mode 8 is a Horizontal_Up Prediction mode and is applicable to the case in which the pixel values A, B, C, D, I, J, K, L, and M are “available”. In this case, the prediction pixel values of pixels a to p are generated according to the equations (11):

prediction pixel values of pixel a=(I+J+1)>>1

prediction pixel values of pixel b=(I+2J+K+2)>>2

prediction pixel values of pixels c,e=(J+K+1)>>1

prediction pixel values of pixels d,f=(J+2K+L+2)>>2

prediction pixel values of pixels g,i=(K+L+1)>>1

prediction pixel values of pixels h,j=(K+3L+2)>>2

prediction pixel values of pixels k,l,m,n,o,p=L (11)

With reference to FIG. 11, description is given next of encoding standards in 4×4 pixel-intra prediction modes (Intra_{—}4×4_pred_mode) for the luminance signal. In the example of FIG. 11, depicted are a target block C that comprises 4×4 pixels and is subject to encoding, together with blocks A and B that comprise 4×4 pixels and are adjacent to the target block C.

In this case, it is considered that the Intra_{—}4×4_pred_mode of the target block C is highly correlated to the Intra_{—}4×4_pred_modes of the blocks A and B. Higher coding efficiency is achievable by performing encoding processing as follows, by using the correlation:

Specifically, in the example of FIG. 11, the Intra_{—}4×4_pred_modes of the blocks A and B are represented by Intra_{—}4×4_pred_modeA and the Intra_{—}4×4_pred_modeB, respectively, and MostProbableMode is defined as the following equation (12):

MostProbableMode=Min(Intra_{—}4×4_pred_modeA,Intra_{—}4×4_pred_modeB) (12)

Specifically, MostProbableMode is set for either the block A or B that is assigned a smaller mode_number.

In bitstreams, two values of prev_intra 4×4_pred_mode_flag [luma4×4BlkIdx] and rem_intra4×4_pred_mode [luma4×4BlkIdx] are defined as parameters for the target block C, and decoding processing is performed by processing based on pseudo codes indicated by the following equations (13), such that values of Intra_{—}4×4_pred_mode and Intra4×4 PredMode [luma4×4 BlkIdx] for the target block C are obtainable:

if (prev_intra4×4_pred_mode_flag[luma4×4 BlkIdx])Intra4×4PredMode[luma4×4BlkIdx]=MostProbableMode

else

if (rem_intra4×4_pred_mode[luma4×4BlkIdx]<MostProbableMode)

Intra4×4PredMode[luma4×4BlkIdx]=rem_intra4×4_pred_mode[luma4×4BlkIdx]

else

Intra4×4PredMode[luma4×4BlkIdx]=rem_intra4×4_pred_mode[luma4×4BlkIdx]+1 (13)

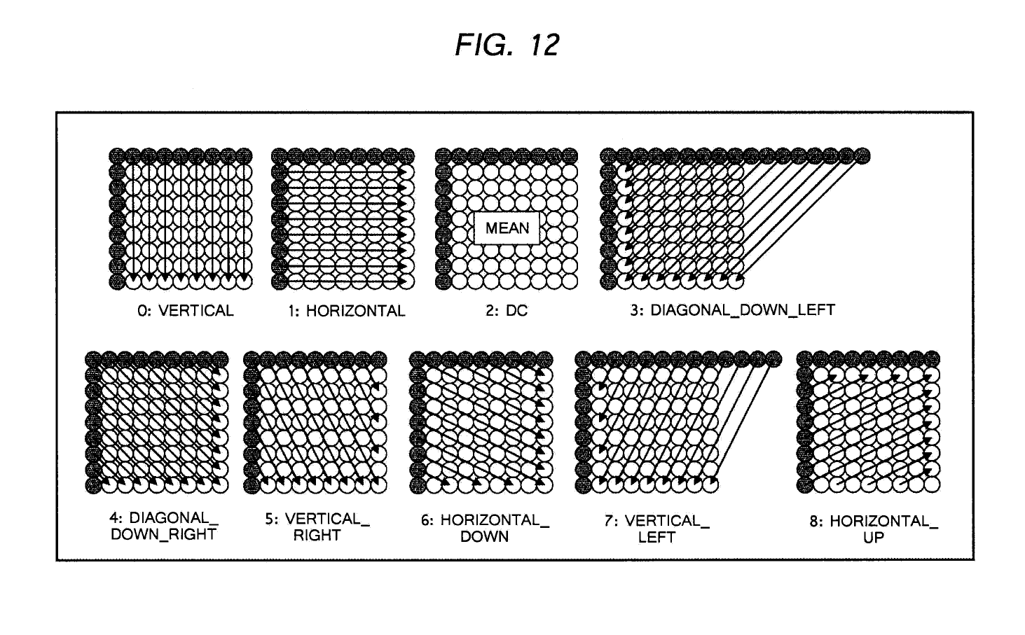

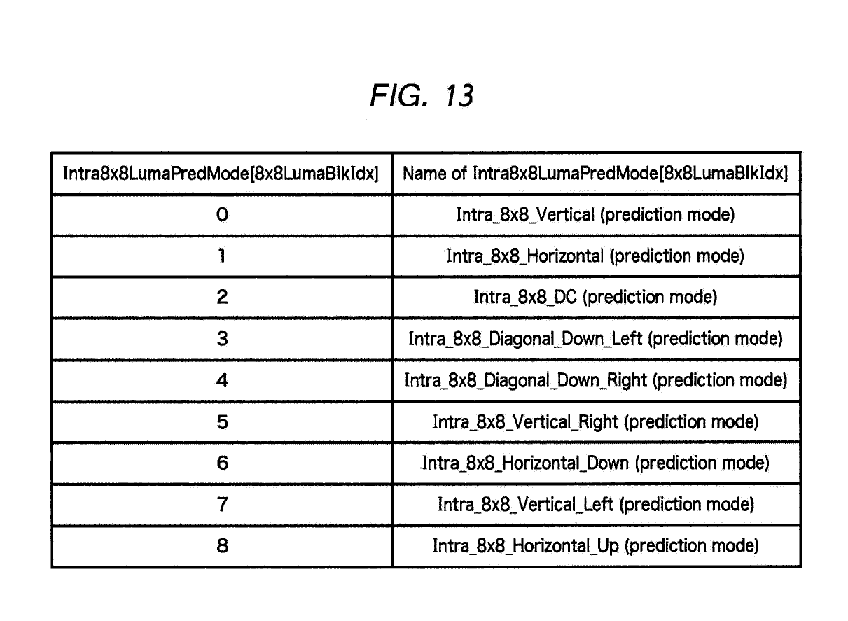

Description is given next of 8×8 pixel-intra prediction modes. FIGS. 12 and 13 depict nine kinds of 8×8 pixel-intra prediction modes (Intra_{—}8×8_pred_mode) for the luminance signal.

The pixel values in the target 8×8 block are represented by p[x, y] (0≦x≦7; 0≦y≦7), and the pixel values of adjacent blocks are represented by p[−1,−1], . . . , p[−1, 15], p[−1, 0], . . . , [p−1, 7].

Low-pass filtering processing is performed on an adjacent pixel prior to generation of prediction values in the 8×8 pixel-intra prediction mode. Herein, the pixel value before the low-pass filtering processing is represented by p[−1,−1], . . . , p[−1, 15], p[−1, 0], . . . , p[−1, 7], and the pixel value after the processing is represented by p′[−1,−1], . . . , p′[−1, 15], p′[−1, 0], . . . , p′[−1, 7].

First, in the case where p[−1,−1] is “available”, p′[0,−1] is calculated according to the following equation (14), and in the case where p[−1,−1] is “not available”, p′[0, −1] is calculated according to the following equation (15):

p′[0,−1]=(p[−1,−1]+2*p[0,−1]+p[1,−1]+2)>>2 (14)

p′[0,−1]=(3*p[0,−1]+p[1,−1]+2)>>2 (15)

p′[x, −1] (x=0, . . . , 7) is calculated according to the following equation (16):

p′[x,−1]=(p[x−1,−1]+2*p[x,−1]+p[x+1,−1]+2)>>2 (16)

In the case where p[x, −1] (x=8, . . . , 15) is “available”, p′[x, −1] (x=8, . . . , 15) is calculated according to the following equation (17):

p′[x,−1]=(p[x−1,−1]+2*p[x,−1]+p[x+1,−1]+2)>>2

p′[15,−1]=(p[14,−1]+3*p[15,−1]+2)>>2 (17)

In the case where p[−1,−1] is “available”, p′[−1, −1] is calculated as follows: Specifically, in the case where p[0,−1] and p[−1, 0] are both available, p′[−1,−1] is calculated according to the following equation (18), and in the case where p[−1, 0] is “unavailable”, p′[−1,−1] is calculated according to the following equation (19). In the case where p[0,−1] is “unavailable”, p′[−1,−1] is calculated according to the following equation (20):

p′[−1,−1]=(p[0,−1]+2*p[−1,−1]+p[−1,0]+2)>>2 (18)

p′[−1,−1]=(3*p[−1,−1]+p[0,−1]+2)>>2 (19)

p′[−1,−1]=(3*p[−1,−1]+p[−1,0]+2)>>2 (20)

In the case where p[−1, y] (y=0, . . . , 7) is “available”, p′[−1, y] (y=0, . . . , 7) is calculated as follows. Specifically, in the case where p[−1,−1] is “available”, p′[−1, 0] is first calculated according to the following equation (21), and in the case where p[−1,−1] is “unavailable”, p′[−1, 0] is calculated according to the following equation (22):

p′[−1,0]=(p[−1,−1]+2*p[−1,0]+p[−1,1]+2)>>2 (21)

p′[−1,0]=(3*p[−1,0]+p[−1,1]+2)>>2 (22)

Further, p′[−1, y] (y=1, . . . , 6) is calculated according to the following equation (23), and p′[−1, 7] is calculated according to the equation (24):

p[−1,y]=(p[−1,y−1]+2*p[−1,y]+p[−1,y+1]+2)>>2 (23)

p′[−1,7]=(p[−1,6]+3*p[−1,7]+2)>>2 (24)

Prediction values in the intra prediction modes depicted in FIGS. 8 and 9 are generated as following by using p′ thus calculated:

Mode 0 is a Vertical Prediction mode and is applicable to the case in which p[x, −1] (x=0, . . . , 7) is “available”.

The prediction value pred8×8_{L} [x, y] is generated according to the following equation (25):

pred8×8_{L}[x,y]=p′[x,−1]x,y=0, . . . , 7 (25)

Mode 1 is a Horizontal Prediction mode and is applicable to the case in which p[−1, y] (y=0, . . . , 7) is “available”. The prediction value pred8×8_{L} [x, y] is generated according to the following equation (26):

pred8×8_{L}[x,y]=p′[−1,y]x,y=0, . . . , 7 (26)

Mode 2 is a DC Prediction mode and the prediction value pred8×8_{L} [x, y] is generated as follows. Specifically, in the case where p[x, −1] (x=0, . . . , 7) and p[−1, y] (y=0, . . . , 7) are both “available”, the prediction value pred8×8_{L} [x, y] is generated according to the following equation (27):

$$\begin{matrix}[ Formula 1 ] & \\ Pred 8 \times {8}_{L} [ x , y ] = ( {\sum }_{{x}^{′} = 0}^{7} {P}^{′} [ {x}^{′} , - 1 ] + {\sum }_{{y}^{′} = 0}^{7} {P}^{′} [ - 1 , y ] + 8 ) >> 4 & ( 27 )\end{matrix}$$

In the case where p[x, −1] (x=0, . . . , 7) is “available” but p[−1, y] (y=0, . . . , 7) is “unavailable”, the prediction value pred8×8_{L} [x, y] is generated according to the following equation (28):

$$\begin{matrix}[ Formula 2 ] & \\ Pred 8 \times {8}_{L} [ x , y ] = ( {\sum }_{{x}^{′} = 0}^{7} {P}^{′} [ {x}^{′} , - 1 ] + 4 ) >> 3 & ( 28 )\end{matrix}$$

In the case where p[x, −1] (x=0, . . . , 7) is “unavailable” but p[−1, y] (y=0, . . . , 7) is “available”, the prediction value pred8×8_{L} [x, y] is generated according to the following equation (29):

$$\begin{matrix}[ Formula 3 ] & \\ Pred 8 \times {8}_{L} [ x , y ] = ( {\sum }_{{y}^{′} = 0}^{7} {P}^{′} [ - 1 , y ] + 4 ) >> 3 & ( 29 )\end{matrix}$$

In the case where p[x, −1] (x=0, . . . , 7) and p[−1, y] (y=0, . . . , 7) are both “unavailable”, the prediction value pred8×8_{L} [x, y] is generated according to the following equation (30):

pred8×8_{L}[x,y]=128 (30)

It is to be noted that the equation (30) is applicable to the case of 8-bit input.

Mode 3 is a Diagonal_Down_Left_prediction mode and the prediction value pred8×8_{L} [x, y] is generated as follows. Specifically, the Diagonal_Down_Left_prediction mode is applicable to the case where p[x, −1], x=0, . . . , 15 is “available”, and the prediction pixel value where x=7 and y=7 is generated according to the following equation (31), and the other prediction pixel value is generated according to the following equation (32):

pred8×8_{L}[x,y]=(p′[14,−1]+3*p[15,−1]+2)>>2 (31)

red8×8_{L}[x,y]=(p′[x+y,−1]+2*p′[x+y+1,−1]+p′[x+y+2,−1]+2)>>2 (32)

Mode 4 is a Diagonal_Down_Right_prediction mode and the prediction value pred8×8_{L} [x, y] is generated as follows. Specifically, the Diagonal_Down_Right_prediction mode is applicable to the case where p[x, −1], x=0, . . . , 7 and p[−1, y], y=0, . . . , 7 are “available”, and the prediction pixel value where x>y is generated according to the following equation (33), and the prediction pixel value where x<y is generated according to the following equation (34). The prediction pixel value where x=y is generated according to the following equation (35):

pred8×8_{L}[x,y]=(p′[x−y−2,−1]+2*p′[x−y−1,−1]+p′[x−y,−1]+2)>>2 (33)

pred8×8_{L}[x,y]=(p′[−1,y−x−2]+2*p′[−1,y−x−1]+p′[−1,y−x]+2)>>2 (34)

pred8×8_{L}[x,y]=(p′[0,−1]+2*p′[−1,−1]+p′[−1,0]+2)>>2 (35)

Mode 5 is a Vertical_Right_prediction mode and the prediction value pred8×8_{L} [x, y] is generated as follows.

Specifically, the Vertical_Right_prediction mode is applicable to the case where p[x, −1], x=0, 7 and p[−1, y], y=−1, 7 are “available”. For now, zVR is defined as the following equation (36):

zVR=2*x−y (36)

Herein, in the case where zVR is any of 0, 2, 4, 6, 8, 10, 12, and 14, pixel prediction values are generated according to the following equation (37), and in the case where zVR is any of 1, 3, 5, 7, 9, 11, and 13, pixel prediction values are generated according to the following equation (38):

pred8×8_{L}[x,y]=[x−(y>>1)−1,−1]+p′[x−(y>>1),−1]+1)>>1 (37)

pred8×8_{L}[x,y]=(p′[x−(y>>1)−2,−1]+2*p′[x−(y>>1)−1,−1]+p′[x−(y>>1),−1]+2)>>2 (38)

In the case where zVR is −1, pixel prediction values are generated according to the following equation (39). In the case other than this, specifically, in the case where zVR is any of −2, −3, −4, −5, −6, and −7, pixel prediction values are generated according to the following equation (40):

pred8×8_{L}[x,y]=(p′[−1,0]+2*p′[−1,−1]+p′[0,−1]+2)>>2 (39)

pred8×8_{L}[x,y]=(p′[−1,y−2*x−1]+2*p′[−1,y−2*x−2]+p′[−1,y−2*x−3]+2)>>2 (40)

Mode 6 is a Horizontal_Down_prediction mode and the prediction value pred8×8_{L} [x, y] is generated as follows. Specifically, the Horizontal_Down_prediction mode is applicable to the case where p[x, −1], x=0, 7 and p[−1, y], y=−1, . . . , 7 are “available”. For now, zVR is defined as the following equation (41):

zHD=2*y−x (41)

Herein, in the case where zHD is any of 0, 2, 4, 6, 8, 10, 12, and 14, pixel prediction values are generated according to the following equation (42), and in the case where zHD is any of 1, 3, 5, 7, 9, 11, and 13, prediction pixel values are generated according to the following equation (43):

pred8×8_{L}[x,y]=(p′[−1,y−(x−1)−1]+p′[−1,y−(x>>1)+1]>>1 (42)

pred8×8_{L}[x,y]=(p′[−1,y−(x>>1)−2]+2*p′[−1,y−(x>>1)−1]+p′[−1,y−(x>>1)]+2)>>2 (43)

In the case where zHD is −1, prediction pixel values are generated according to the following equation (44). In the case where zHD is a value other than this, specifically, is any of −2, −3, −4, −5, −6, and −7, prediction pixel values are generated according to the following equation (45):

pred8×8_{L}[x,y]=[−1,0]+2*p[−1,−1]+p′[0,−1]+2)>>2 (44)

pred8×8_{L}[x,y]=(p′[x−2*y−1,−1]+2*p′[x−2*y−2,−1]+p′[x−2*y−3,−1]+2)>>2 (45)

Mode 7 is a Vertical_Left_prediction mode and the prediction value pred8×8_{L} [x, y] is generated as follows. Specifically, the Vertical_Left_prediction mode is applicable to the case where p[x, −1], x=0, . . . , 15 is “available”, and prediction pixel values are generated according to the following equation (46) in the case where y=0, 2, 4, 6; in the case other than this, specifically, in the case where y=1, 3, 5, 7, prediction pixel values are generated according to the following equation (47):

pred8×8_{L}[x,y]=(p′[x+(y>>1),−1]+p′[x+(y>>1)+1,−1]+1)>>1 (46)

pred8×8_{L}[x,y]=(p′[x+(y>>1),−1]+2*p′[x+(y>>1)+1,−1]+p′[x+(y>>1)+2,−1]+2)>>2 (47)

Mode 8 is a Horizontal_Up_prediction mode and the prediction value pred8×8_{L} [x, y] is generated as follows. Specifically, the Horizontal_Up_prediction mode is applicable to the case where p[−1, y], y=0, . . . , 7 is “available”. In the following, zHU is defined as the following equation (48):

zHU=x+2*y (48)

In the case where the value of zHU is any of 0, 2, 4, 6, 8, 10, and 12, prediction pixel values are generated according to the following equation (49), and in the case where the value of zHU is any of 1, 3, 5, 7, 9, and 11, prediction pixel values are generated according to the following equation (50):

pred8×8_{L}[x,y]=(p′[−1,y+(x−1)]+p′[−1,y+(x>>1)+1]+1)>>1 (49)

pred8×8_{L}[x,y]=(p′[−1,y+(x>>1)] (50)

In the case where the value of zHU is 13, prediction pixel values are generated according to the following equation (51), and in the case other than this, specifically, in the case where the value of zHU is larger than 13, prediction pixel values are generated according to the following equation (52):

pred8×8_{L}[x,y]=(p′[−1,6]+3*p′[−1,7]+2)>>2 (51)

pred8×8_{L}[x,y]=p′[−1,7] (52)

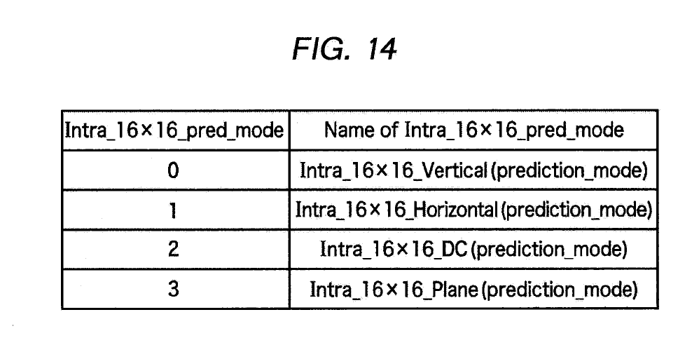

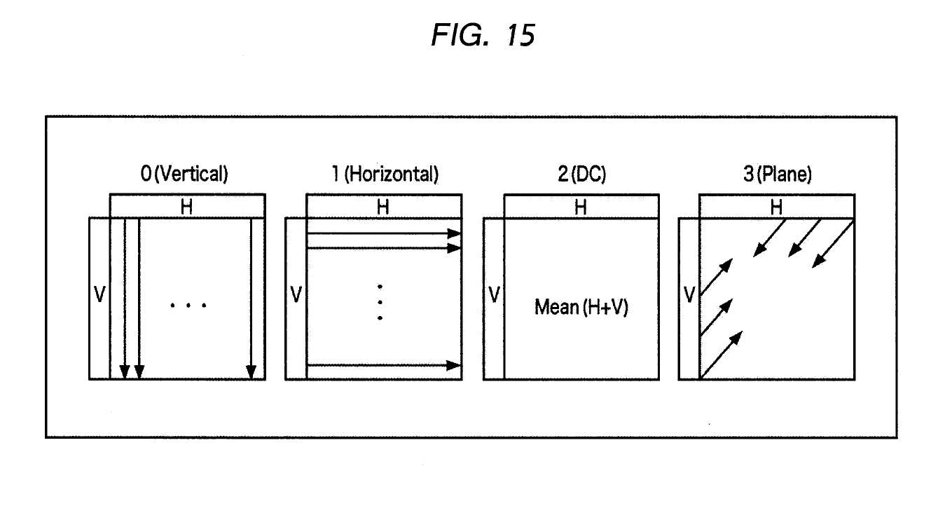

Description is given next of 16×16 pixel-intra prediction modes. FIGS. 14 and 15 depict four kinds of 16×16 pixel-intra prediction modes (Intra_{—}16×16_pred_mode) for the luminance signal.

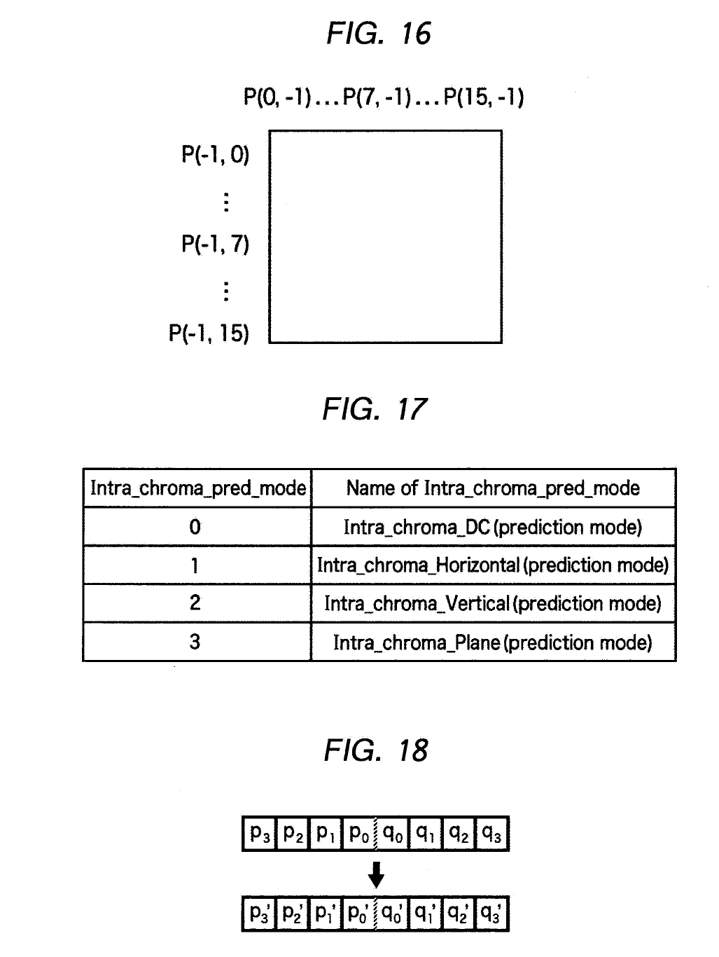

The four kinds of intra prediction modes are described with reference to FIG. 16. In the example of FIG. 16, a target macroblock A to be subjected to intra processing is depicted, and P (x, y); x, y=−1, 0, . . . , 15 indicates pixel values of pixels adjacent to the target macroblock A.

Mode 0 is a Vertical Prediction mode and is applicable to the case in which P (x, −1); x, y=−1, 0, . . . , 15 is “available”. In this case, prediction pixel value Pred (x, y) of the pixels of the target macroblock A is generated according to the following equation (53):

Pred(x,y)=P(x,−1); x,y=0, . . . , 15 (53)

Mode 1 is a Horizontal Prediction mode and is applicable to the case in which P (−1, y); x, y=−1, 0, . . . , 15 is “available”. In this case, prediction pixel values Pred (x, y) of the pixels of the target macroblock A are generated according to the following equation (54):

Pred(x,y)=P(−1,y); x,y=0, . . . , 15 (54)

Mode 2 is a DC Prediction mode, and prediction pixel values Pred (x, y) of the pixels of the target macroblock A are generated according to the following equation (55) in the case where P (x, −1) and P (−1, y); x, y=−1, 0, . . . , 15 are fully “available”.

$$\begin{matrix}[ Formula 4 ] & \\ Pred ( x , y ) = [ {\sum }_{{x}^{′} = 0}^{15} P ( {x}^{′} , - 1 ) + {\sum }_{{y}^{′} = 0}^{15} P ( - 1 , {y}^{′} ) + 16 ] >> 5 \\ with x , y = 0 , … , 15 & ( 55 )\end{matrix}$$

In the case where P (x, −1); x, y=−1, 0, . . . , 15 is “unavailable”, prediction pixel values Pred (x, y) of the pixels of the target macroblock A are generated according to the following equation (56):

$$\begin{matrix}[ Formula 5 ] & \\ Pred ( x , y ) = [ {\sum }_{{y}^{′} = 0}^{15} P ( - 1 , {y}^{′} ) + 8 ] >> 4 with x , y = 0 , … , 15 & ( 56 )\end{matrix}$$

In the case where P (−1, y); x, y=−1, 0, . . . , 15 is “unavailable”, prediction pixel values Pred (x, y) of the pixels of the target macroblock A are generated according to the following equation (57):

$$\begin{matrix}[ Formula 6 ] & \\ Pred ( x , y ) = [ {\sum }_{{y}^{′} = 0}^{15} P ( {x}^{′} , - 1 ) + 8 ] >> 4 with x , y = 0 , … , 15 & ( 57 )\end{matrix}$$

In the case where P (x, −1) and P (−1, y); x, y=−1, 0, . . . , 15 are fully “unavailable”, 128 is used for the prediction pixel value.

Mode 3 is a Plane Prediction mode and is applicable to the case in which P (x, −1) and P (−1, y); x, y=−1, 0, . . . , 15 are fully “available”. In this case, prediction pixel values Pred (x, y) of the pixels of the target macroblock A are generated according to the following equation (58):

$$\begin{matrix}[ Formula 7 ] & \\ Pred ( x , y ) = Clip 1 ( ( a + b \cdot ( x - 7 ) + c \cdot ( y - 7 ) + 16 ) >> 5 ) \\ a = 16 \cdot ( P ( - 1 , 15 ) + P ( 15 , - 1 ) ) \\ b = ( 5 \cdot H + 32 ) >> 6 \\ c = ( 5 \cdot V + 32 ) >> 6 \\ H = {\sum }_{x = 1}^{8} x \cdot ( P ( 7 + x , - 1 ) - P ( 7 - x , - 1 ) ) \\ V = {\sum }_{y = 1}^{8} y \cdot ( P ( - 1 , 7 + y ) - P ( - 1 , 7 - y ) ) & ( 58 )\end{matrix}$$

Description is given next of intra prediction modes for the color difference signal. FIG. 17 depicts four kinds of intra prediction modes (Intra_chroma_pred_modes) for the color difference signal. The intra prediction modes for the color difference signal are set independently of the intra prediction modes for the luminance signal. The intra prediction modes for the color difference signal are set basically the same as the above-described 16×16 pixel-intra prediction mode for the luminance signal.

It is to be noted here that, while the 16×16 pixel-intra prediction mode for the luminance signal is for the 16×16 pixel blocks, the intra prediction mode for the color difference signal is for the 8×8 pixel blocks. Further, as can be seen from FIG. 14 of which the description has been made and FIG. 17, the mode numbers are not correspondent to each other between these modes.

Herein, reference is made to the definition of pixel values and adjacent pixel values of the target macroblock A to be subjected to a 16×16 pixel-intra prediction mode for the luminance signal described with reference to FIG. 16. For example, the pixel value of a pixel adjacent to the target macroblock A to be subjected to intra processing (8×8 pixels for the color difference signal) is set as P (x, y); x, y=−1, 0, . . . , 7.

Mode 0 is a DC Prediction mode, and prediction pixel values Pred (x, y) of the pixels of the target macroblock A are generated according to the following equation (59) in the case where P (x, −1) and P (−1, y); x, y=−1, 0, . . . , 7 are fully “available”:

$$\begin{matrix}[ Formula 8 ] & \\ Pred ( x , y ) = ( ( {\sum }_{n = 0}^{7} ( P ( - 1 , n ) + P ( n , - 1 ) ) ) + 8 ) >> 4 \\ with x , y = 0 , … , 7 & ( 59 )\end{matrix}$$

In the case where P (−1, y); x, y=−1, 0, . . . , 7 is “unavailable”, prediction pixel values Pred (x, y) of the pixels of the target macroblock A are generated according to the following equation (60):

$$\begin{matrix}[ Formula 9 ] & \\ Pred ( x , y ) = [ ( {\sum }_{n = 0}^{7} P ( n , - 1 ) ) + 4 ] >> 3 with x , y = 0 , … , 7 & ( 60 )\end{matrix}$$

In the case where P (x, −1); x, y=−1, 0, . . . , 7 is “unavailable”, prediction pixel values Pred (x, y) of the pixels of the target macroblock A are generated according to the following equation (61):

$$\begin{matrix}[ Formula 10 ] & \\ Pred ( x , y ) = [ ( {\sum }_{n = 0}^{7} P ( - 1 , n ) ) + 4 ] >> 3 with x , y = 0 , … , 7 & ( 61 )\end{matrix}$$

Mode 1 is a Horizontal Prediction mode and is applicable to the case in which P (−1, y); x, y=−1, 0, . . . , 7 is “available”. Prediction pixel values Pred (x, y) of the pixels of the target macroblock A are generated according to the following equation (62):

Pred(x,y)=P(−1,y); x,y=0, . . . , 7 (62)

Mode 2 is a Vertical Prediction mode and is applicable to the case in which P (x, −1); x, y=−1, 0, . . . , 7 is “available”. In this case, prediction pixel values Pred (x, y) of the pixels of the target macroblock A are generated according to the following equation (63):

Pred(x,y)=P(x,−1); x,y=0, . . . , 7 (63)

Mode 3 is a Plane Prediction mode and is applicable to the case in which P (x, −1) and P (−1, y); x, y=−1, 0, . . . , 7 are “available”. In this case, prediction pixel values Pred (x, y) of the pixels of the target macroblock A are generated according to the following equation (64):

$$\begin{matrix}[ Formula 11 ] & \\ Pred ( x , y ) = Clip 1 ( a + b \cdot ( x - 3 ) + c \cdot ( y - 3 ) + 16 ) >> 15 ; \\ x , y = 0 , … , 7 \\ a = 16 \cdot ( P ( - 1 , 7 ) + P ( 7 , - 1 ) ) \\ b = ( 17 \cdot H + 16 ) >> 5 \\ c = ( 17 \cdot V + 16 ) >> 5 \\ H = {\sum }_{x = 1}^{4} x \cdot [ P ( 3 + x , - 1 ) - P ( 3 - x , - 1 ) ] \\ V = {\sum }_{y = 1}^{4} y \cdot [ P ( - 1 , 3 + y ) - P ( - 1 , 3 - y ) ] & ( 64 )\end{matrix}$$

### Deblocking Filter

A deblocking filter is described next. The deblocking filter 21 is included in the motion compensation loop and is configured to remove block distortion in decoded images. Block distortion is thus suppressed from propagating to images to be referenced in motion compensation processing.

For the processing of the deblocking filter, the following three methods (a) to (c) are selectable according to two parameters included in encoding data, i.e., deblocking_filter_control_present_flag included in Picture Parameter Sets RBSP (Raw Byte Sequence Payload) and disable_deblocking_filter_idc included in Slice Headers:

(a) The processing is performed on block boundaries and macroblock boundaries;

(b) The processing is performed on macroblock boundaries; and

(c) The processing is not performed.

Regarding the quantization parameter QP, QPY is used in the case where the following processing is applied to luminance signals, and QPC is used in the case where the processing is applied to color difference signals. In motion vector encoding, inter prediction, and entropy coding (CAVLC/CABAC), the processing is performed as pixel values of different slices being “not available”; meanwhile, in the deblocking filtering processing, the processing is performed as pixel values of different slices but of the same picture being “available”.

In the following, as depicted in FIG. 18, the pixel values before the deblocking filtering processing are defined as p0-p3 and q0-q3, whereas the pixel values after the processing are defined as p0′-p3′ and q0′-q3′.

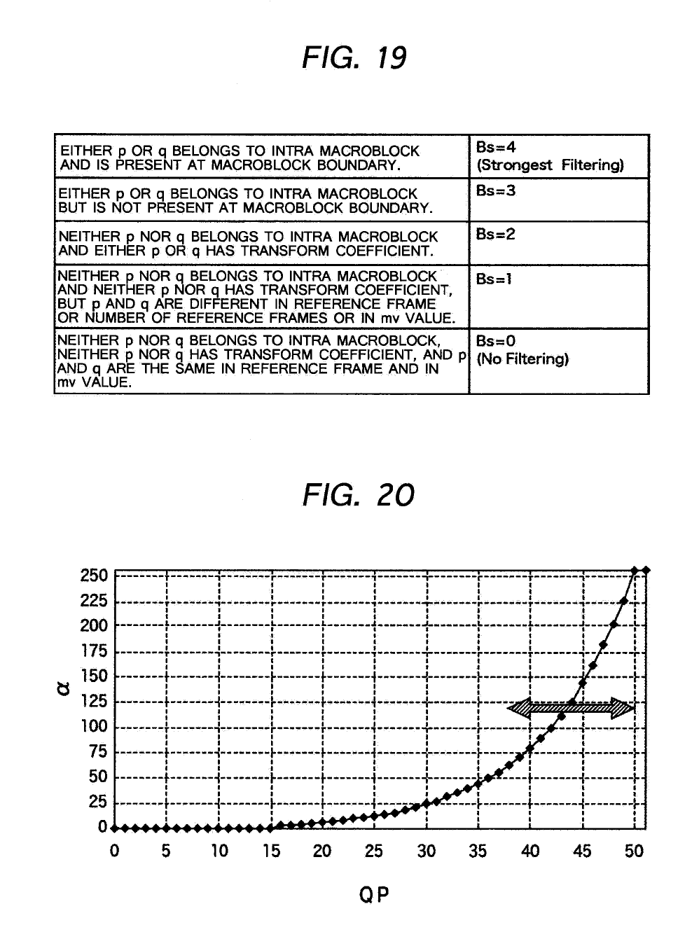

Prior to the deblocking filtering processing, Bs (Boundary Strength) is defined as indicated in the table in FIG. 19 for p and q in FIG. 18.

The deblocking filtering processing is performed on (p2, p1, p0, q0, q1, q2) in FIG. 18 on the condition that the equations (65) and (66) are established.

Bs≧0 (65)

|p0−q0|<α; |p1−p0|<β; |q1−q0|<β (66)

The values of α and β in the equation (66) are set by default as follows according to the QP; however, the user are allowed to adjust the intensity thereof according to the two parameters of the encoding data, i.e., slice_alpha_c0_offset_div2 and slice_beta_offset_div2 that are included in slice headers, as indicated by the arrow in the graph shown in FIG. 20.

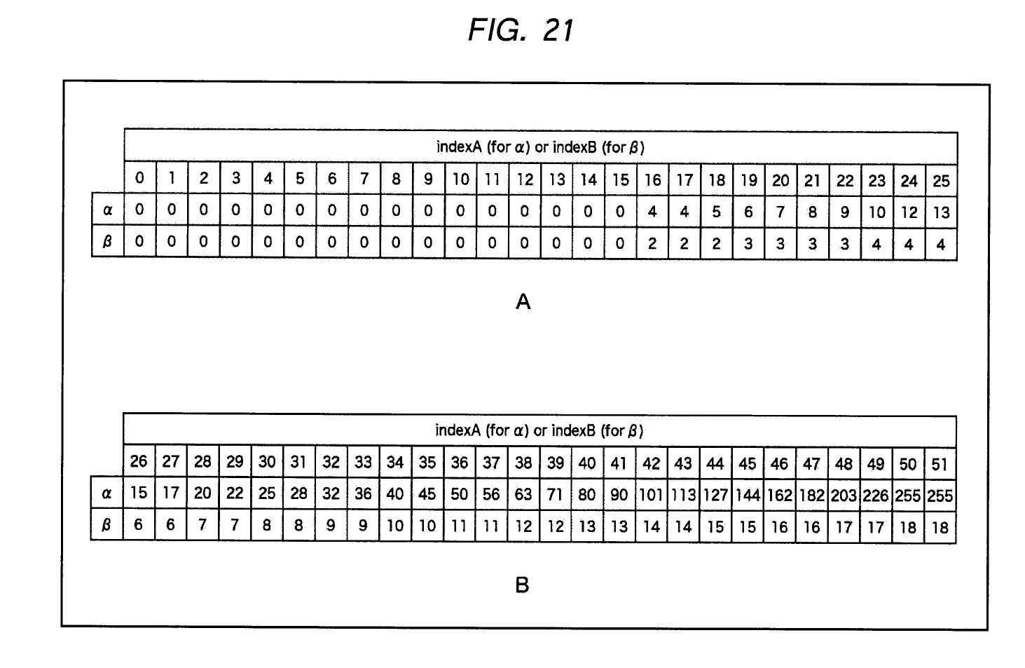

As seen from the table shown in FIG. 21, α is calculable from indexA. Likewise, β is calculable from indexB. The indexA and indexB are defined as the following equations (67) to (69):

qPₐᵥ=(qPₚ+qP_{q}+1)>>1 (67)

indexA=Clip3(0,51,qPₐᵥ+FilterOffsetA) (68)

indexB=Clip3(0,51,qPₐᵥ+FilterOffsetB) (69)

In the equations (68) and (69), FilterOffsetA and FilterOffsetB correspond to the adjustment made by the user.

As described hereinafter, defined methods for the deblocking filtering processing are different between the cases where Bs<4 and where Bs=4. In the case where Bs<4, pixel values p′0 and q′0 after the deblocking filtering processing are found by the following equations (70) to (72):

Δ=Clip3(−t_{c},t_{c}((((q0−p0)<<2)+(p1−q1)+4)>>3)) (70)

p′0=Clip1(p0+Δ) (71)

q′0=Clip1(q0+Δ) (72)

Herein, t_{c} is calculable from the following equation (73) or (74). Specifically, in the case where the value of chromaEdgeFlag is “0”, t_{c} is calculable from the following equation (73):

t_{c}=t_{c0}+((aₚ<β)?1:0)+((a_{q}<β)?1:0) (73)

In the case where the value of chromaEdgeFlag is other than “0”, t_{c} is calculable from the following equation (74):

t_{c}=t_{c0}+1 (74)

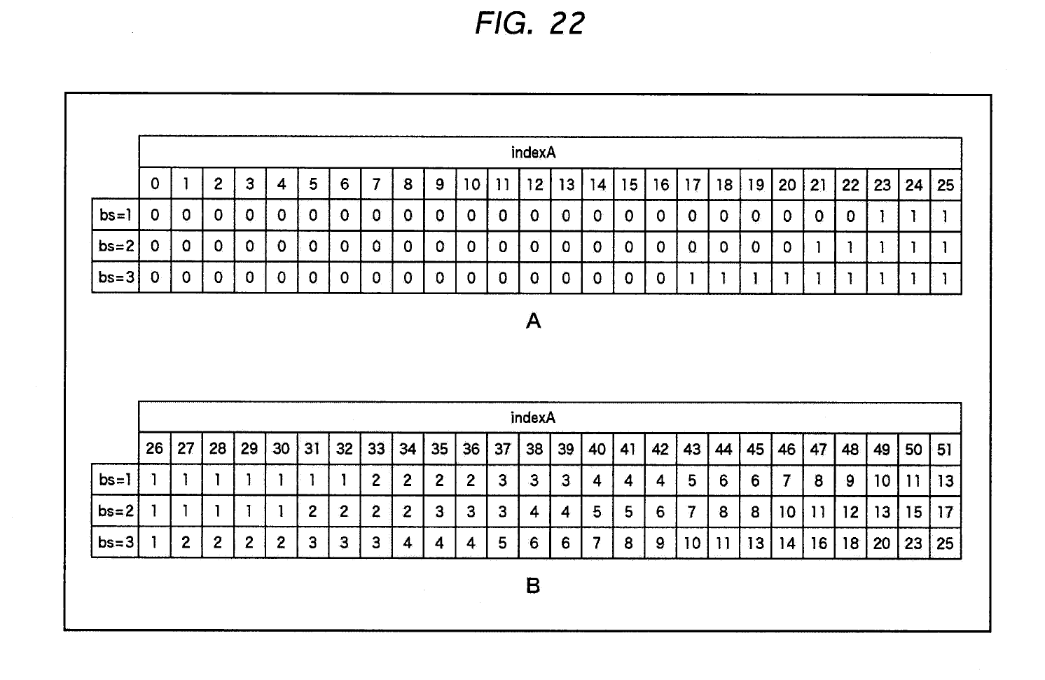

The value of t_{c0} is defined as shown in the tables shown in A of FIG. 22 and in B of FIG. 22 according to the values of Bs and indexA.

The values of aₚ and a_{q} of the equation (73) are calculable from the following equations (75) and (76):

aₚ=|p2−p0| (75)

a_{q}=|q2−q0| (76)

The pixel value p′1 after the deblocking filtering processing is found as follows. Specifically, in the case where the value of chromaEdgeFlag is “0” and also the value of aₚ is equal to or less than β, p′1 is found by the following equation (77):

p′1=p1+Clip3(−t_{c0},t_{c0},(p2+((p0+q0+1)>>1)−(p1<<1))>>1) (77)

In the case where the equation (77) is not established, p′1 is found by the following equation (78):

p′1=p1 (78)

The pixel value q′1 after the deblocking filtering processing is found as follows. Specifically, in the case where the value of chromaEdgeFlag is “0” and also the value of a_{q} is equal to or less than β, q′1 is found by the following equation (79):

q′1=q1+Clip3(−t_{c0},t_{c0},(q2+((p0+q0+1)>>1)−(q1<<1))>>1) (79)

In the case where the equation (79) is not established, q′1 is found by the following equation (80):

q′1=q1 (80)

The values of p′2 and q′2 are unchanged from the values p2 and q2 before the filtering. Specifically, p′2 is found by the following equation (81) and q′2 is found by the following equation (82):

p′2=p2 (81)

q′2=q2 (82)

In the case where Bs=4, the pixel value p′i (i=0.2) after the deblocking filtering is found as follows. In the case where the value of chromaEdgeFlag is “0” and the condition indicated by the following equation (83) is established, p′0, p′1, and p′2 are found by the following equations (84) to (86):

ap<β&&|p0−q0|<((α>>2)+2) (83)

p′0=(p2+2×p1+2×p0+2×q0+q1+4)>>3 (84)

p′1=(p2+p1+p0+q0+2)>>2 (85)

p′2=(2×p3+3×p2+p1+p0+q0+4)>>3 (86)

In the case where the condition indicated by the equation (83) is not established, p′0, p′1, and p′2 are found by the following equations (87) to (89):

p′0=(2×p1+p0+q1+2)>>2 (87)

p′1=p1 (88)

p′2=p2 (89)

The pixel value q′i (I=0.2) after the deblocking filtering processing is found as follows. Specifically, in the case where the value of chromaEdgeFlag is “0” and the conditions indicated by the following equation (90) is established, q′0, q′1, and q′2 are found by the following equations (91) to (93):

aq<β&&|p0−q0|<((α>>2)+2) (90)

q′0=(p1+2×p0+2×q0+2×q1+q2+4)>>3 (91)

q′1=(p0+q0+q1+q2+2)>>2 (92)

q′2=(2×q3+3×q2+q1+q0+p4+4)>>3 (93)

In the case where the condition indicated by the equation (90) is not established, q′0, q′1, and q′2 are found by the following equations (94) to (96):

q′0=(2×q1+q0+p1+2)>>2 (94)

q′1=q1 (95)

q′2=q2 (96)

### Examples of Extended Macroblocks

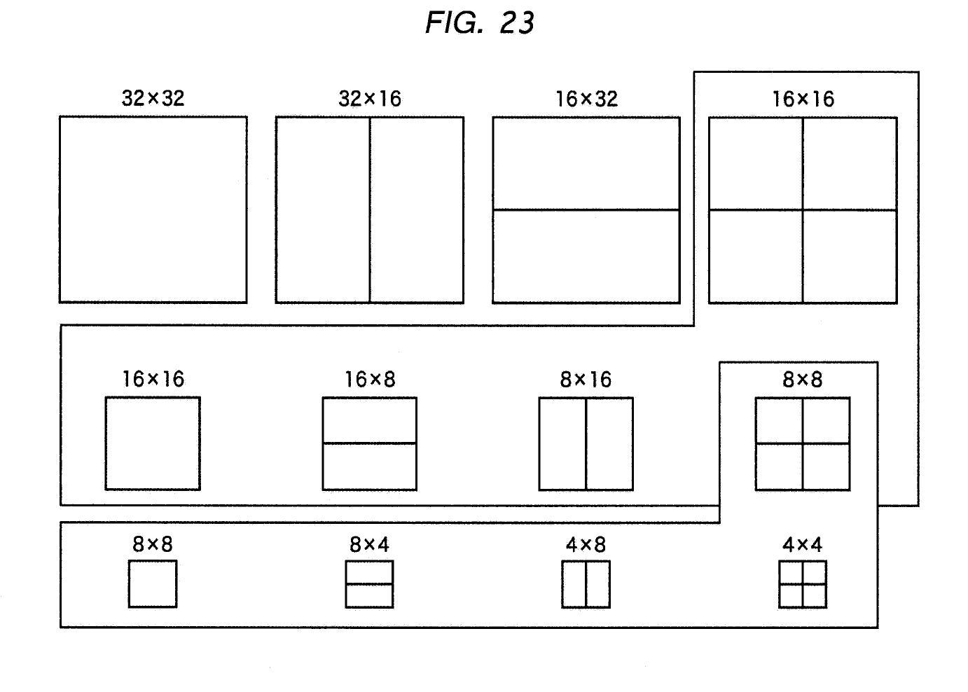

According to H.264/AVC standard, the macroblock size is 16×16 pixels. Setting the macroblock size to 16×16 pixels however is not optimal for larger picture frames such as UHD (Ultra High Definition; 4000×2000 pixels) which can be an object of next-generation coding standards. In the image coding apparatus 101, as depicted in FIG. 23, macroblock sizes of, for example, 32 pixels×32 pixels or 64×64 pixels are adopted in some cases.

FIG. 23 depicts exemplary block sizes proposed in Non-patent Document 2. In Non-patent Document 2, the macroblock size is extended to 32×32 pixels.

In the upper row of FIG. 23, macroblocks comprising 32×32 pixels are depicted in order from the left, each macroblock being divided into the blocks (partitions) of 32×32 pixels, 32×16 pixels, 16×32 pixels, and 16×16 pixels. In the middle row of FIG. 23, blocks comprising 16×16 pixels are depicted in order from the left, each block being divided into the blocks of 16×16 pixels, 16×8 pixels, 8×16 pixels, and 8×8 pixels. In the lower row of FIG. 23, blocks comprising 8×8 pixels are depicted in order from the left, each block being divided into the blocks of 8×8 pixels, 8×4 pixels, 4×8 pixels, and 4×4 pixels.

In other words, the macroblock of 32×32 pixels is processable in the blocks of 32×32 pixels, 32×16 pixels, 16×32 pixels, and 16×16 pixels that are depicted in the upper row of FIG. 23.

The 16×16 pixel block depicted on the right of the upper row is processable, as in the case of H.264/AVC standard, in the blocks of 16×16 pixels, 16×8 pixels, 8×16 pixels, and 8×8 pixels that are depicted in the middle row.

The 8×8 pixel block depicted on the right of the middle row is processable, as in the case of H.264/AVC standard, in the blocks of 8×8 pixels, 8×4 pixels, 4×8 pixels, and 4×4 pixels that are depicted in the lower row.

These blocks are categorized into the following three hierarchies: A first hierarchy refers to the blocks of 32×32 pixels, 32×16 pixels, and 16×32 pixels depicted in the upper row of FIG. 23; a second hierarchy refers to the blocks of 16×16 pixels depicted on the right in the upper row, and 16×16 pixels, 16×8 pixels, and 8×16 pixels that are depicted in the middle row; and a third hierarchy refers to the blocks of 8×8 pixels depicted on the right in the middle row, and 8×8 pixels, 8×4 pixels, 4×8 pixels, and 4×4 pixels that are depicted in the lower row.

Adopting the hierarchical structure as depicted in FIG. 23 ensures scalability with the current macroblock size according to H.264/AVC standard of 16×16 pixel blocks or smaller, while defining larger blocks as supersets thereof.

### Selection of Prediction Mode

To achieve higher coding efficiency, selection of an appropriate prediction mode matters. For the image coding apparatus 101, a method of selecting from two mode determining methods, i.e., High Complexity Mode and Low Complexity Mode, is considered. In this method, in either mode, the respective cost function values for the prediction modes are calculated, and the prediction mode that give a minimum value is selected as an optimum mode for a relevant block or macroblock.

The cost function value in High Complexity Mode is calculable according to the following equation (97):

Cost(Mode εΩ)=D+λ×R (97)

In the equation (97), Ω indicates the universal set of candidate modes for encoding the relevant block or macroblock. Further, D indicates the energy difference between the decoded image and the input image in the case of performing encoding in the relevant prediction Mode. λ is the Lagrange undetermined multiplier given as a function of a quantization parameter. R is the total amount of encoding including orthogonal transform coefficients in the case of performing encoding in the relevant Mode.

Specifically, in order to perform encoding in High Complexity Mode, provisional encoding processing has to be performed once in all candidate Modes so as to calculate the above parameters of D and R, which entails a larger amount of arithmetic operation.

On the other hand, the cost function value in Low Complexity Mode is calculable by the following equation (98):

Cost(Mode εΩ)=D+QP2Quant(QP)×HeaderBit (98)

In the equation (98), unlike High Complexity Mode, D indicates the energy difference between the prediction image and the input image. QP2Quant (QP) is given as a function of a quantization parameter QP. HeaderBit indicates the amount of encoding relating to the information belonging to the Header that does not include orthogonal transform coefficients, such as motion vectors and modes.

Specifically, in Low Complexity Mode, while prediction processing has to be performed per candidate Mode, decoded images are not used, and encoding processing thus does not have to be performed. As such, a smaller amount of arithmetic operation suffices as compared with High Complexity Mode.

In a High Profile, for example, selection between a 4×4 orthogonal transform and an 8×8 orthogonal transform is performed based either on the above-described High Complexity Mode or Low Complexity Mode.

### Detailed Configuration Example

In the above image coding apparatus 101, adaptive loop filtering processing is applied to image encoding processing. The image coding apparatus 101 has the adaptive loop filter 111 in the motion prediction/compensation loop, classifies I picture images according to intra prediction mode information, and performs calculation of optimum filter coefficients and filtering processing on the classes decided by the classification.

As has been described with reference to FIGS. 6 to 17, the intra prediction mode information includes, actually, information on prediction block sizes set per macroblock and information on prediction modes indicating a plurality of kinds of prediction methods for the same prediction block size set per motion prediction block.

In the image decoding apparatus 101, classification is performed on I picture images according to information on the prediction block size per macroblock, i.e., according to which of the intra 4×4, 8×8, or 16×16 mode is for use, in intra prediction mode information.

Description is given below in detail of a configuration of the adaptive loop filter 111. Adaptive filtering processing is performed within the motion compensation loop at the adaptive loop filter 111 based on the method proposed in Non-patent Document 1. It is to be noted that the present embodiment is different from Non-patent Document 1 in that the following processing is performed on I pictures.

Specifically, in Non-patent Document 1, processing for minimizing degradation is performed by a Wiener filter with the screen as a whole set as one class.

Meanwhile, at the adaptive loop filter 111, classification is performed on macroblocks that define a flat region and macroblocks that define an edge or texture region, based on the information relating to which of the intra 4×4, 8×8, or 16×16 mode the relevant macroblocks are encoded, with respect to I pictures. Then, processing for minimizing degradation is performed by the Wiener filter on the classes.

More specifically, the intra 16×16 mode tends to be used for on-screen flat regions; meanwhile, the intra 4×4 mode or the intra 8×8 mode tends to be used for regions including an edge and/or texture.

Block distortion is apt to occur in on-screen flat regions, and mosquito distortion is apt to occur in regions including an edge and/or texture. The method proposed in Non-patent Document 1 however hardly reduces local distortion within the screen.

Thus, at the adaptive loop filter 111, classification is performed on I pictures according to which of the prediction block sizes the mode in which a macroblock is encoded has, and calculation of filter coefficients and adaptive filtering processing are performed on the classes.

In other words, the inside of a screen is divided into classes of a flat region and an edge/texture region and adaptive filtering processing is performed on the classes.

This allows for not only improvement of coding efficiency but also reduction in local distortion within the screen. Block distortion in the flat region and mosquito distortion in the edge/texture region are reduced, with the result that distortion is reduced in the screen as a whole and the processing of the deblocking filter 21 may be skipped.

Further, the image quality of I pictures, on which the quality of the image depends, is improved, with the result that the image qualities of GOPs are improved as a whole.

Encoding parameter information of intra prediction mode information is used at the adaptive loop filter 111, and thus flag information for classification, i.e., information for discerning classes, does not have to be sent to the decoding side. Hence, reduction in coding efficiency is unlikely to occur, which may otherwise be caused due to overhead of flag information.

Description is given hereinafter of an example in which, for example, a macroblock encoded by intra 16×16 is classified into a first class defining the flat region class, and macroblocks encoded by the other intra prediction modes are classified into a second class defining the class of regions including an edge and/or texture. More specifically, images are classified depending on whether the sizes are larger or smaller than the 16×16, which is the normal macroblock size (a maximum prediction block size) defined by H.264/AVC coding standard.

The present invention is applicable to classification in, for example, three classes of intra 4×4, intra 8×8, and intra 16×16, without being limited to the above description.

Classification may also be performed according to the kinds of prediction modes, e.g., DC prediction, Vertical prediction, . . . , in the prediction block sizes, which are an encoding parameter per motion prediction block, without being limited to the above-described prediction block sizes in the intra prediction mode information (intra prediction mode information).

Specifically, for example, Vertical prediction and Horizontal prediction are zero-order-hold prediction modes and are prone to mosquito noise. For this reason, blocks or macroblocks encoded for Vertical prediction and Horizontal prediction may be classified in the edge/texture region class and blocks or macroblocks encoded in the other prediction modes may be classified in the flat region class, so as to be subjected to adaptive filtering processing.

The present invention is also applicable to intra pictures adopting extended macroblock sizes described with reference to FIG. 23. In this case, for example, images are classified depending on whether the sizes are larger or smaller than 16×16, which is the normal macroblock size (maximum prediction block size) defined according to H.264/AVC coding standard. Specifically, sizes larger than the normal macroblock size defined by a coding standard or equal to or larger than the normal macroblock size defined by a coding standard, e.g., 32×32, tend to be used for on-screen flat regions, hence being classifiable into the flat region class.

### Configuration Example of Adaptive Loop Filter

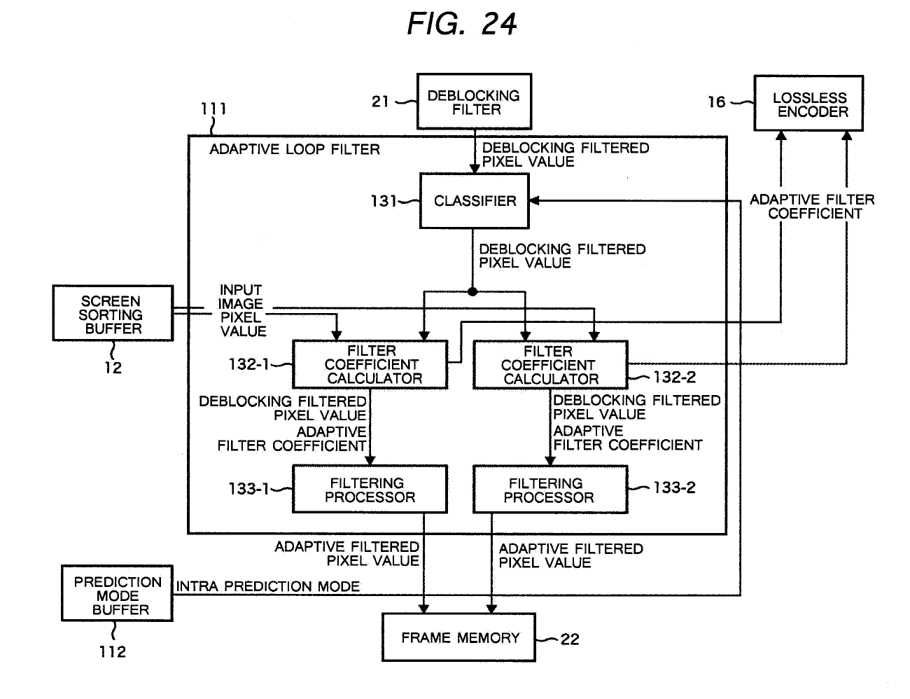

FIG. 24 is a block diagram depicting a configuration example of the adaptive loop filter 111 in the case where a picture to be input is an I picture. The illustration of a configuration example of the adaptive loop filter 111 for a case of a picture other than the I picture is not made for simplifying the description.

In the example of FIG. 24, the adaptive loop filter 111 includes a classifier 131, filter coefficient calculators 132-1 and 132-2, and filtering processors 133-1 and 133-2.

The deblocking filtered pixel values from the deblocking filter 21 are supplied to the classifier 131. Intra prediction mode information containing information on which of the intra 4×4, 8×8, or 16×16 prediction mode the macroblocks are encoded in is supplied from the prediction mode buffer 112 to the classifier 131.

The classifier 131 classifies the deblocking filtered pixel values of the macroblocks by those belonging to the first class and those belonging to the second class according to the intra prediction mode information and the classification results are supplied to the filter coefficient calculators 132-1 and 132-2, respectively. In the example of FIG. 24, as described above, macroblocks encoded by intra 16×16 are classified to the first class defining the flat region class and macroblocks encoded in the other intra prediction modes are classified to the second class defining the class of regions including an edge and/or texture.

Input image pixel values are supplied from the screen sorting buffer 12 to the filter coefficient calculators 132-1 and 132-2. The filter coefficient calculators 132-1 and 132-2 calculate adaptive filter coefficients for the first class and the second class.

The adaptive filter coefficients that have been calculated by the filter coefficient calculator 132-1 for the first class are supplied to the filtering processor 133-1 together with the deblocking filtered pixel values of the first class. The adaptive filter coefficients that have been calculated by the filter coefficient calculator 132-2 for the second class are supplied to the filtering processor 133-2 together with the deblocking filtered pixel values of the second class. The adaptive filter coefficients thus calculated for the classes are also supplied to the lossless encoder 16.

The filtering processor 133-1 performs filtering processing by using the adaptive filter coefficients for the first class on the deblocking filtered pixel values of the first class. The filtering processor 133-2 performs filtering processing by using the adaptive filter coefficients for the second class on the deblocking filtered pixel values of the second class. The adaptive filtered pixel values are output to the frame memory 22.

### Description of Encoding Processing of Image Coding Apparatus

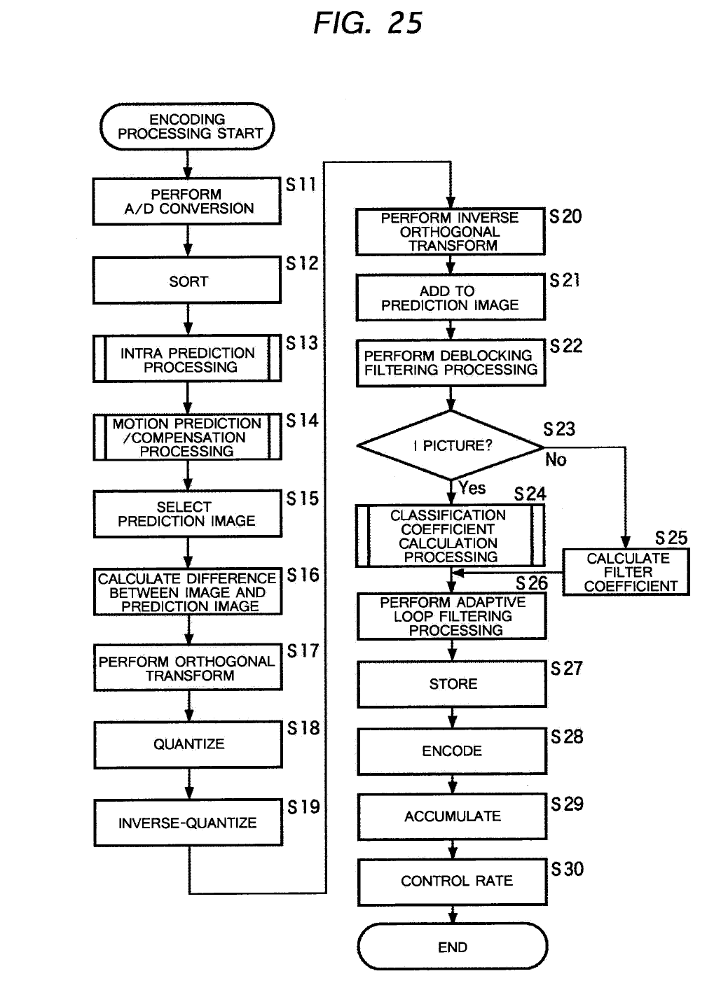

Description is given next of encoding processing of the image coding apparatus 101 of FIG. 5 with reference to the flowchart of FIG. 25.

In step S11, the A/D converter 11 performs A/D conversion on input images. In step S12, the screen sorting buffer 12 retains the images supplied from the A/D converter 11 and sorts the pictures thereof from the display order into the encoding order.

In the case where processing target images to be supplied from the image sorting buffer 12 are images of blocks to be subjected to intra processing, decoded images to be referenced are read from the frame memory 22, so as to be supplied to the intra predictor 24 through the switch 23.

Based on these images, in step S13, the intra predictor 24 performs intra prediction on the pixels of the blocks to be processed in all candidate intra prediction modes. Pixels yet to be subjected to be filtered by the deblocking filter 21 and the adaptive loop filter 111 are used as decoded pixels to be referenced.

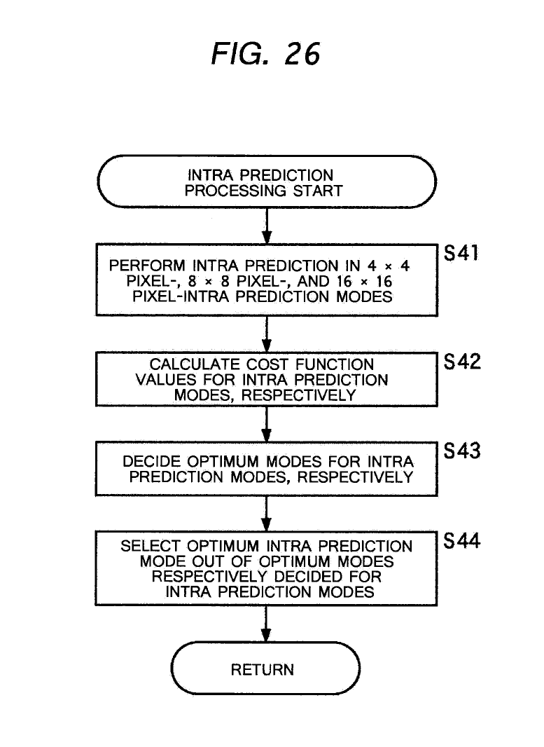

While the intra prediction processing in step S13 is described in detail later with reference to FIG. 26, intra prediction is performed in all the candidate intra prediction modes by this processing, and cost function values for all the candidate intra prediction modes are calculated. Based on the calculated cost function values, an optimum intra prediction mode is selected, and prediction images generated by intra prediction in the optimum intra prediction mode and the cost function values thereof are supplied to the prediction image selector 26.

In the case where the processing target images to be supplied from the screen sorting buffer 12 are images to be subjected to inter processing, images to be referenced are read from the frame memory 22 and are supplied to the motion predictor/compensator 25 through the switch 23. Based on these images, in step S14, the motion predictor/compensator 25 performs motion prediction/compensation processing.

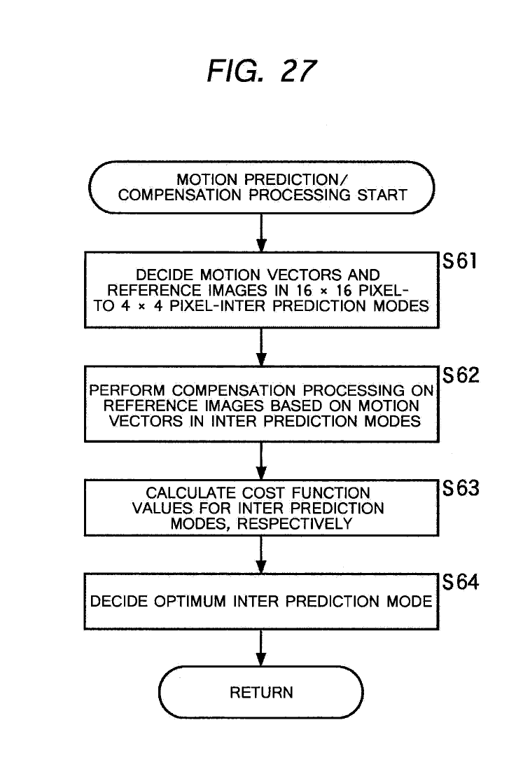

The motion prediction/compensation processing in step S14 is described in detail later with reference to FIG. 27. Motion prediction processing is performed in all the candidate inter prediction modes by this processing, cost function values are calculated for all the candidate inter prediction modes, and an optimum inter prediction mode is decided based on the cost function values calculated. Prediction images generated in the optimum inter prediction mode and the cost function values thereof are supplied to the prediction image selector 26.

In step S15, the prediction image selector 26 decides, based on the cost function values output from the intra predictor 24 and the motion predictor/compensator 25, either the optimum intra prediction mode or the optimum inter prediction mode as an optimum prediction mode. Then, the prediction image selector 26 selects prediction images in the decided optimum prediction mode and supplies the images to the arithmetic operators 13 and 20. These prediction images are used for the arithmetic operations in steps S16 and S21 to be described later.

The selection information on the prediction images is supplied to the intra predictor 24 or to the motion predictor/compensator 25. In the case where a prediction image in the optimum intra prediction mode is selected, the intra predictor 24 supplies the information indicating the optimum intra prediction mode, i.e., the intra prediction mode information, to the lossless encoder 16.

In the case where a prediction image in the optimum inter prediction mode is selected, the motion predictor/compensator 25 outputs the information indicating the optimum inter prediction mode, and in addition, information corresponding to the optimum inter prediction mode as needed, to the lossless encoder 16. The information corresponding to the optimum inter prediction mode includes motion vector information and reference frame information.

In step S16, the arithmetic operator 13 calculates difference between the images sorted in step S12 and prediction images selected in step S15. The prediction images are supplied through the prediction image selector 26 from the motion predictor/compensator 25 in the case of inter prediction and from the intra predictor 24 in the case of intra prediction, to the arithmetic operator 13.

The difference data has a smaller data amount as compared with the original image data. Hence, the data amount is compressible in comparison with the case of encoding the image itself.

In step S17, the orthogonal transformer 14 performs an orthogonal transform on the difference information supplied from the arithmetic operator 13. Specifically, an orthogonal transform such as discrete cosine transform or Karhunen-Loeve transform is performed, such that the transform coefficients are output.

In step S18, the quantizer 15 quantizes the transform coefficients. In quantizing, the rate is controlled as described in the processing in step S30 to be described later.

The difference information thus quantized is decoded locally as described hereinafter. In step S19, the inverse quantizer 18 performs inverse quantization on the transform coefficients quantized by the quantizer 15 with characteristics corresponding to the characteristics of the quantizer 15. In step S20, the inverse orthogonal transformer 19 performs an inverse orthogonal transform on the transform coefficients inverse-quantized by the inverse quantizer 18 with characteristics corresponding to the characteristics of the orthogonal transformer 14.

In step S21, the arithmetic operator 20 adds prediction images to be input through the prediction image selector 26 to the locally decoded difference information and generates locally decoded images (images corresponding to the inputs to the arithmetic operator 13).

In step S22, the deblocking filter 21 performs deblocking filtering processing on the images output from the arithmetic operator 20, so as to remove block distortion. The decoded images from the deblocking filter 21 are output to the adaptive loop filter 111.

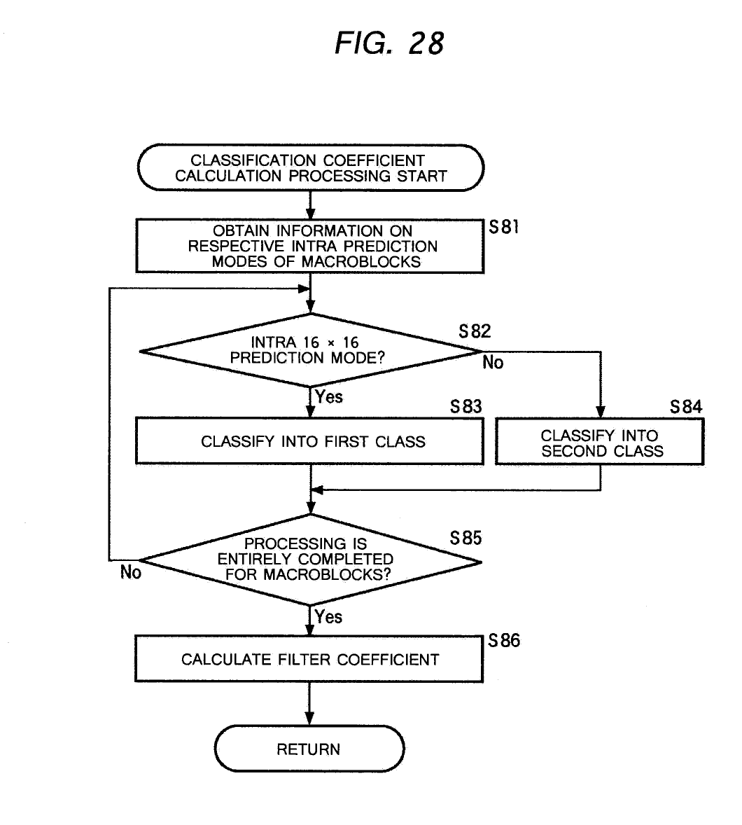

In step S23, the adaptive loop filter 111 determines whether or not the decoded image from the deblocking filter 21 is an I picture. In the case where an I picture is determined in step S23, the adaptive loop filter 111 performs classification coefficient calculation processing in step S24. The classification coefficient calculation processing is described in detail later with reference to FIG. 28. The adaptive loop filter 111 for this case is configured as depicted in FIG. 24.

Through the processing in step S23, classification is performed according to intra prediction modes and adaptive filter coefficients are calculated for the classes. The adaptive filter coefficients thus calculated are supplied to the associated filtering processors 133-1 and 133-2 together with the deblocking filtered pixel values classified by class.

Meanwhile, in the case where an I picture is not determined in step S23, the processing proceeds to step S25. In step S25, the adaptive loop filter 111 calculates one adaptive filter coefficient for the screen as a whole. The illustration of a detailed configuration example of the adaptive loop filter 111 in the case other than the I picture is not made.

The information of the adaptive loop filter coefficients calculated in step S24 or S25 is supplied to the lossless encoder 16 and is encoded by the lossless encoder 16 in step S28 to be described later, so as to be added to the headers of compressed images.

In step S26, the adaptive loop filter 111 uses the calculated adaptive filter coefficients to perform adaptive loop filtering processing on the deblocking filtered pixel values. The adaptive filtered pixel values are output to the frame memory 22.

Specifically, especially in the case of I pictures, the filtering processor 133-1 uses the adaptive filter coefficients for the first class on the deblocking filtered pixel values of the first class to perform filtering processing. The filtering processor 133-2 uses the adaptive filter coefficients for the second class on the deblocking filtered pixel values of the second class to perform filtering processing.

In step S27, the frame memory 22 stores the filtered images. The frame memory 22 is also supplied with images that are yet to be filtered by the deblocking filter 21 and the adaptive loop filter 111 from the arithmetic operator 20 for storage thereon.

Meanwhile, the transform coefficients quantized in the above-described step S18 are supplied also to the lossless encoder 16. In step S28, the lossless encoder 16 encodes the quantized transform coefficients output from the quantizer 15. In other words, the difference images are subjected to lossless coding such as variable length coding or binary arithmetic coding for compression.

At this time, the adaptive filter coefficients input to the lossless encoder 16 in the above-described step S24 or S25, as well as intra prediction mode information from the intra predictor 24 that has been input to the lossless encoder 16 in the above-described step S15, or the optimum inter prediction mode-related information from the motion predictor/compensator 25, is encoded to be included into header information.

For example, information indicating inter prediction modes is encoded per macroblock. Motion vector information and reference frame information are encoded per target block. Filter coefficients are encoded per slice or picture parameter set.

In step S29, the accumulation buffer 17 accumulates difference images as compressed images. The compressed images thus accumulated in the accumulation buffer 17 are appropriately read therefrom to be transmitted to the decoding side through a channel.

In step S30, the rate controller 27 controls the rate of quantizing operation of the quantizer 15 based on the compressed images accumulated in the accumulation buffer 17 so as to protect from overflow or underflow.

### Description of Intra Prediction Processing

Description is given next of the intra prediction processing in step S13 of FIG. 25 with reference to the flowchart of FIG. 26. In the example of FIG. 26, a case of a luminance signal is exemplarily described.

In step S41, the intra predictor 24 performs intra prediction in intra prediction modes for 4×4 pixels, 8×8 pixels, and 16×16 pixels, respectively.

The intra prediction modes for the luminance signal include prediction modes based on nine kinds of block units in 4×4 pixels and 8×8 pixels, as well as prediction modes based on four kinds of macroblock units in 16×16 pixels. The intra prediction modes for the color difference signal include prediction modes based on four kinds of block units in 8×8 pixels. The intra prediction modes for the color difference signal are settable independently of the intra prediction modes for the luminance signal. With respect to the 4×4 pixel- and 8×8 pixel-intra prediction modes for the luminance signal, one intra prediction mode is defined per block of a luminance signal of 4×4 pixels and 8×8 pixels. With respect to the 16×16 pixel-intra prediction mode for the luminance signal and the intra prediction mode for the color difference signal, one prediction mode is defined on one macroblock.

Specifically, the intra predictor 24 performs intra prediction on the pixels of processing target blocks with reference to decoded images to be read from the frame memory 22 and supplied through the switch 23. The intra prediction processing is each performed in intra prediction modes, such that prediction images are generated in the intra prediction modes, respectively. Pixels that have not undergone filtering by the deblocking filter 21 and the adaptive loop filter 111 are used as decoded pixels to be referenced.

In step S42, the intra predictor 24 calculates cost function values with respect to the 4×4 pixel-, 8×8 pixel-, and 16×16 pixel-intra prediction modes. Herein, the cost functions of the equation (97) or (98) are used to find the cost function values.

In step S43, the intra predictor 24 decides optimum modes in the 4×4 pixel-, 8×8 pixel-, and 16×16 pixel-intra prediction modes, respectively. Specifically, as described above, the intra 4×4 prediction mode and intra 8×8 prediction mode each have nine kinds of prediction modes, and the intra 16×16 prediction mode has four kinds of prediction modes. Hence, the intra predictor 24 decides an optimum intra 4×4 prediction mode, an optimum intra 8×8 prediction mode, and an optimum intra 16×16 prediction mode from the above based on the cost function values calculated in step S42.

In step S44, the intra predictor 24 selects an optimum intra prediction mode based on the cost function values calculated in step S42 out of the optimum modes that have been decided respectively on the 4×4 pixel-, 8×8 pixel-, and 16×16 pixel-intra prediction modes in step S44. More specifically, of the optimum modes decided for 4×4 pixels, 8×8 pixels, and 16×16 pixels, a mode that has a minimum cost function value is selected as an optimum intra prediction mode. The intra predictor 24 supplies the prediction images generated in the optimum intra prediction mode and the cost function values thereof to the prediction image selector 26.

### Description of Motion Prediction/Compensation Processing

Description is given next of the motion prediction/compensation processing in S14 of FIG. 25 with reference to the flowchart of FIG. 27.

In step S61, the motion predictor/compensator 25 decides motion vectors and reference images for eight kinds of inter prediction modes comprising 16×16 pixels to 4×4 pixels, respectively. More specifically, motion vectors and reference images are decided for processing target blocks in the inter prediction modes, respectively.

In step S62, the motion predictor/compensator 25 performs motion prediction and compensation processing on the reference images based on the motion vectors decided in step S61 for the eight kinds of inter prediction modes comprising 16×16 pixels to 4×4 pixels. Prediction images are generated in the inter prediction modes through this motion prediction and compensation processing.

In step S63, the motion predictor/compensator 25 calculates cost function values represented by the above-described equation (97) or (98) for the eight kinds of inter prediction modes comprising 16×16 pixels to 4×4 pixels.

In step S64, the motion predictor/compensator 25 compares the cost function values calculated with respect to the inter prediction modes in step S63 and decides the prediction mode that gives a minimum value as an optimum inter prediction mode. Then, the motion predictor/compensator 25 supplies prediction images generated in the optimum inter prediction mode and the cost function values thereof to the prediction image selector 26.

### Description of Classification Coefficient Calculation Processing

Description is given next of the classification coefficient calculation processing in step S24 of FIG. 25 with reference to the flowchart of FIG. 28. The classification coefficient calculation processing of FIG. 28 is processing to be performed by the adaptive loop filter 111 in the case of I pictures in FIG. 24.

The deblocking filtered pixel values from the deblocking filter 21 are supplied to the classifier 131. The intra prediction mode information containing information on which of the intra 4×4, 8×8, or 16×16 prediction mode the macroblocks are encoded in is also supplied from the prediction mode buffer 112 to the classifier 131.

In step S81, the classifier 131 obtains intra prediction mode information for the macroblocks.

In step S82, the classifier 131 references the obtained intra prediction mode information to determine whether or not the intra prediction mode for one macroblock is an intra 16×16 prediction mode. In the case where an intra 16×16 prediction mode is determined in step S82, the classifier 131 classifies the deblocking filtered pixel value to the first class in step S83. More specifically, the pixel values of the macroblocks determined as being in an intra 16×16 prediction mode are classified to the first class defining the flat portion region class.

In the case where an intra 16×16 prediction mode is not determined in step S82, the classifier 131 classifies the deblocking filtered pixel value to the second class in step S84. More specifically, the pixel values of the macroblocks determined as being in an intra 8×8 or intra 4×4 prediction mode and not in an intra 16×16 prediction mode are classified to the second class defining the edge/texture region class.

After step S83 or S84, the processing proceeds to step S85. In step S85, the classifier 131 determines whether or not the processing on the macroblocks configuring the screen has been entirely completed, and in the case where it is determined that the processing has not been completed, the processing returns to step S82 and the processing thereafter is repetitively performed.

In the case where it is determined that the processing has been completed entirely for the macroblocks in step S85, the classifier 131 supplies the pixel values of the macroblocks classified by class to the associated filter coefficient calculators 132-1 and 132-2, and the processing proceeds to step S86.

In other words, the classifier 131 supplies the pixel values of the macroblocks classified in the first class to the filter coefficient calculator 132-1 and supplies the pixel values of the macroblocks classified in the second class to the filter coefficient calculator 132-2.

In step S86, the filter coefficient calculators 132-1 and 132-2 calculate adaptive filter coefficients for the first and second classes.

Specifically, the filter coefficient calculator 132-1 calculates the adaptive filter coefficients for the first class so as to minimize the residue between input image pixel values from the screen sorting buffer 12 and the deblocking filtered pixel values of the first class. The adaptive filter coefficients calculated for the first class are supplied to the filtering processor 133-1 together with the deblocking filtered pixel values of the first class.

The filter coefficient calculator 132-2 calculates the adaptive filter coefficients for the second class so as to minimize the residue between input image pixel values from the screen sorting buffer 12 and the deblocking filtered pixel values of the second class. The adaptive filter coefficients calculated for the second class are supplied to the filtering processor 133-2 together with the deblocking filtered pixel values of the second class. The adaptive filter coefficients for the classes are also supplied to the lossless encoder 16.

As such, in the case where pixels to be subjected to filtering processing are of an I picture, the pixels are classified into the class of macroblocks in a flat portion region and the class of macroblocks in a region including an edge and/or texture according to the information relating to which of the intra prediction block sizes the mode in which the encoding took place has, and adaptive loop filtering processing is performed per class.

This allows for reduction in local distortion within the screen. Further, since the image quality of I pictures are improved, resulting in improvement in image quality of GOPs as a whole.

Moreover, the intra prediction mode information is encoding information (encoding parameter) to be sent to the decoding side, and thus the information for classification does not have to be sent to the decoding side, allowing for prevention of lowering of coding efficiency that may otherwise be caused by sending information for classification.

The encoded compressed images are transmitted through a specific channel, so as to be decoded by an image decoding apparatus.

### Configuration Example of Image Decoding Apparatus

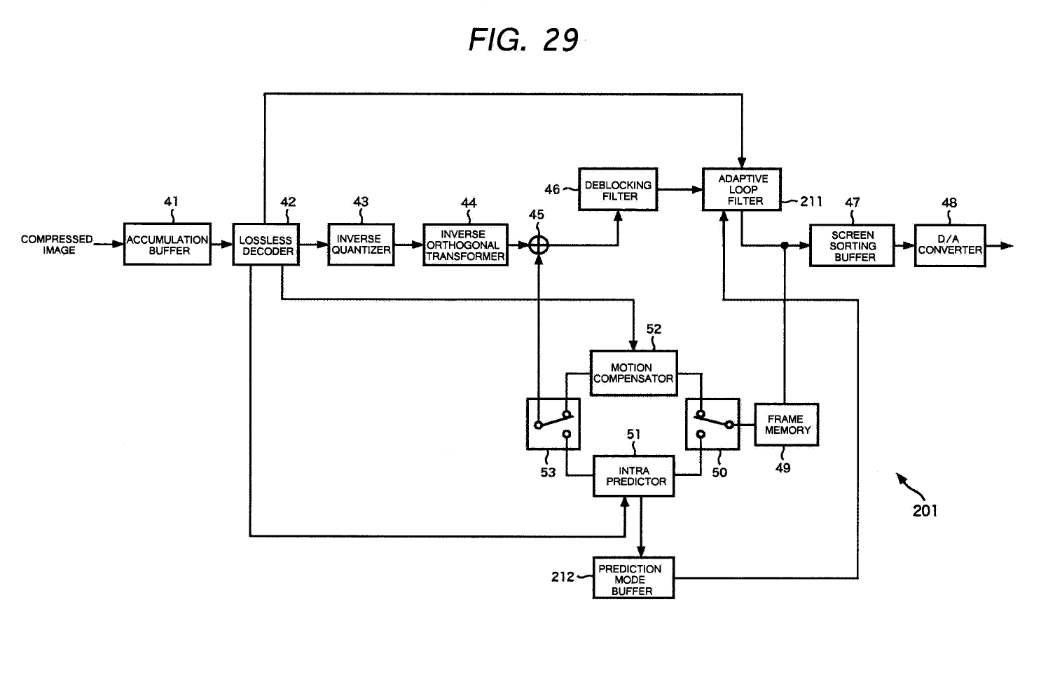

FIG. 29 depicts one embodiment of an image processing apparatus in the form of an image decoding apparatus to which the present invention is applied.

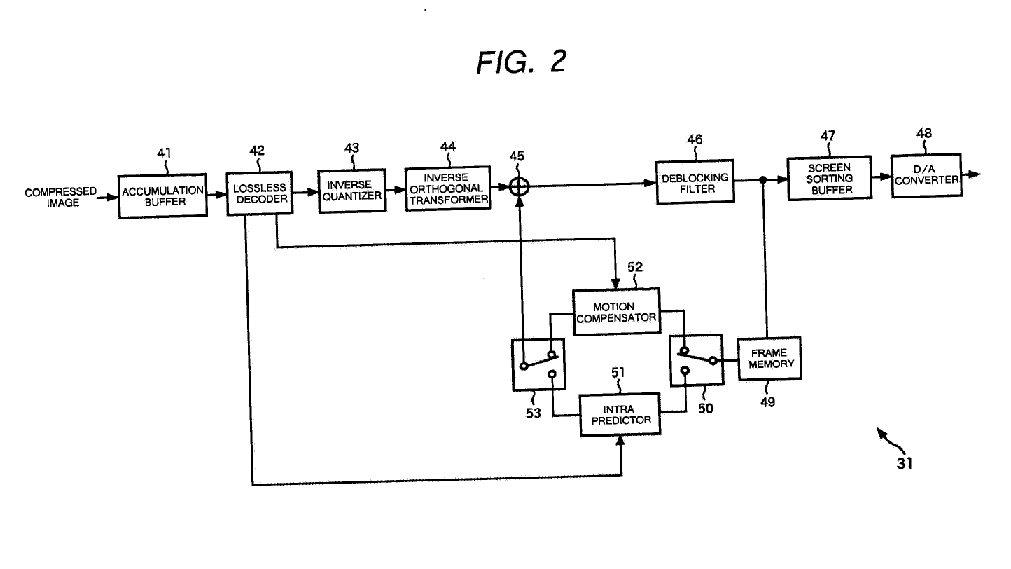

Like the image decoding apparatus 31 of FIG. 2, an image decoding apparatus 201 of FIG. 29 includes the accumulation buffer 41, the lossless decoder 42, the inverse quantizer 43, the inverse orthogonal transformer 44, the arithmetic operator 45, the deblocking filter 46, the screen sorting buffer 47, the D/A converter 48, the frame memory 49, the switch 50, the intra predictor 51, the motion compensator 52, and the switch 53.

Unlike the image decoding apparatus 31 of FIG. 2, the image decoding apparatus 201 of FIG. 23 additionally includes an adaptive loop filter 211 and a prediction mode buffer 212.

More specifically, the lossless decoder 42, like the lossless decoder 42 of FIG. 2, decodes information that has been supplied from the accumulation buffer 41 and encoded by the lossless encoder 16 of FIG. 5 according to a standard corresponding to the coding standard adopted by the lossless encoder 16. At this time, also decoded is information including motion vector information, reference frame information, prediction mode information, i.e., information indicating an intra prediction mode or an inter prediction mode, and adaptive filter coefficients for the first class and the second class.

The motion vector information and the reference frame information are supplied to the motion compensator 52 per block. The prediction mode information is supplied to the associated portions of the intra predictor 51 and of the motion compensator 52 per macroblock. The adaptive filter coefficients for the classes are supplied to the adaptive loop filter 211 per slice or picture parameter set.

The adaptive loop filter 211 is provided at the back of the deblocking filter 46 and in front of the frame memory 49. Specifically, the adaptive loop filter 211 is provided within the motion compensation loop including the arithmetic operator 45, the deblocking filter 46, the frame memory 49, the switch 50, the motion compensator 52, and the switch 53. In other words, images for use loop within the motion compensation loop.

The adaptive loop filter 211 uses the adaptive filter coefficients supplied from the lossless decoder 42 to perform filtering processing on the decoded images from the deblocking filter 46. Examples of the filter include a Wiener Filter.

It is to be noted that the adaptive loop filter 211 classifies the decoded images from the deblocking filter 46 to classes corresponding to the intra prediction mode information from the prediction mode buffer 212. The adaptive loop filter 211 uses the adaptive filter coefficients supplied from the lossless decoder 42 by the assigned classes to perform filtering processing thereon, such that the filtered images are output to the screen sorting buffer 47 and the frame memory 49.

The prediction mode buffer 212 stores the intra prediction mode information decided by the intra predictor 51.

At the adaptive loop filter 111 of FIG. 5, pixel values of the classes are used for calculation of the adaptive filter coefficients, and the calculated filter coefficients are used to perform filtering processing on the pixel values of the classes. On the other hand, at the adaptive loop filter 211 of FIG. 29, the filter coefficients to be obtained per slice or picture parameter set from the headers of compressed images are used to perform filtering processing on the pixel values of the classes.

### Configuration Example of Adaptive Loop Filter

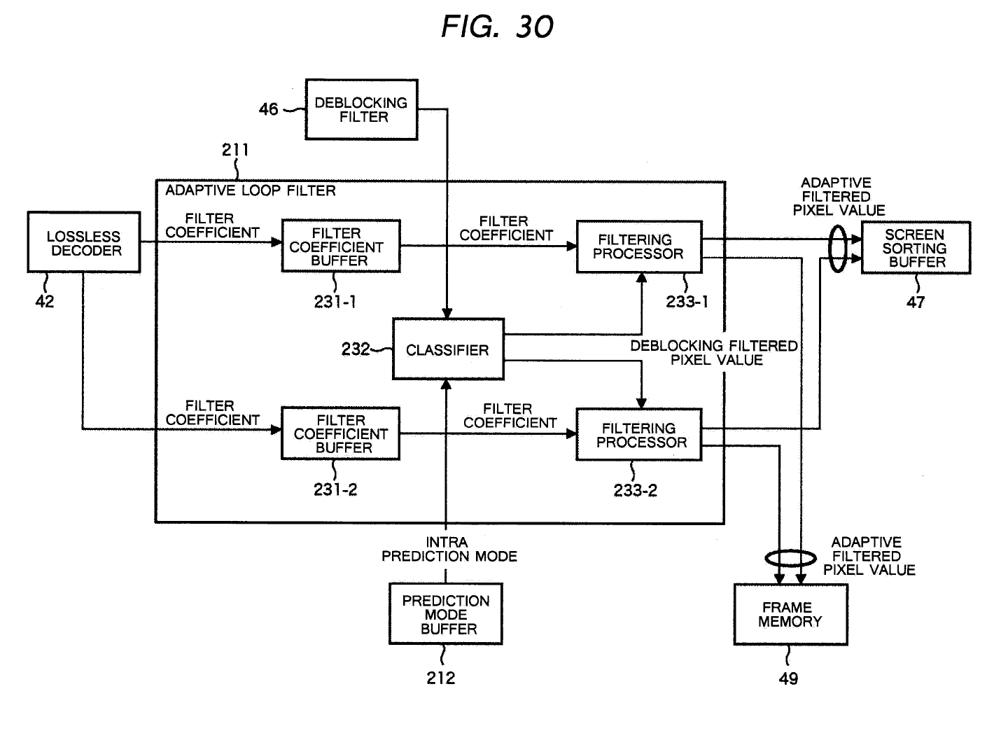

FIG. 30 is a block diagram depicting a configuration example of the adaptive loop filter 211 in the case of I pictures. As in the case of FIG. 24, illustration of a configuration example of the adaptive loop filter 211 in the case other than the I picture is not made for simplifying the description.

In the example of FIG. 30, the adaptive loop filter 211 includes filter coefficient buffers 231-1 and 231-2, a classifier 232, and filtering processors 233-1 and 233-2.

The lossless decoder 42 supplies adaptive filter coefficients for the first class and for the second class, which coefficients are available from picture parameter sets or slice headers, to the filter coefficient buffers 231-1 and 231-2, respectively.

The filter coefficient buffer 231-1 accumulates the adaptive filter coefficients for the first class for supply to the filtering processor 233-1. The filter coefficient buffer 231-2 accumulates the adaptive filter coefficients for the second class for supply to the filtering processor 233-2.

The deblocking filtered pixel values from the deblocking filter 46 are supplied to the classifier 232. Also supplied to the classifier 232 is intra prediction mode information containing information on which of the intra 4×4, 8×8, or 16×16 prediction mode the macroblocks from the prediction mode buffer 212 are encoded in.

The classifier 232 references the intra prediction mode information and classifies the deblocking filtered pixel values by those belonging to the first class and those belonging to the second class, for supply to the filtering processors 233-1 and 233-2, respectively. The macroblocks encoded by intra 16×16 are classified to the first class defining a flat region class and the macroblocks encoded in the other intra prediction modes are classified to the second class defining the class of a region including an edge and/or texture.

The filtering processor 233-1 uses adaptive filter coefficients for the first class from the filter coefficient buffer 231-1 to perform filtering processing on the pixel values classified in the first class. The filtering processor 233-2 uses adaptive filter coefficients for the second class from the filter coefficient buffer 231-2 to perform filtering processing on the pixel values classified in the second class.

The adaptive filtered pixel values are output to the screen sorting buffer 47 and the frame memory 49.

### Description of Decoding Processing of Image Decoding Apparatus

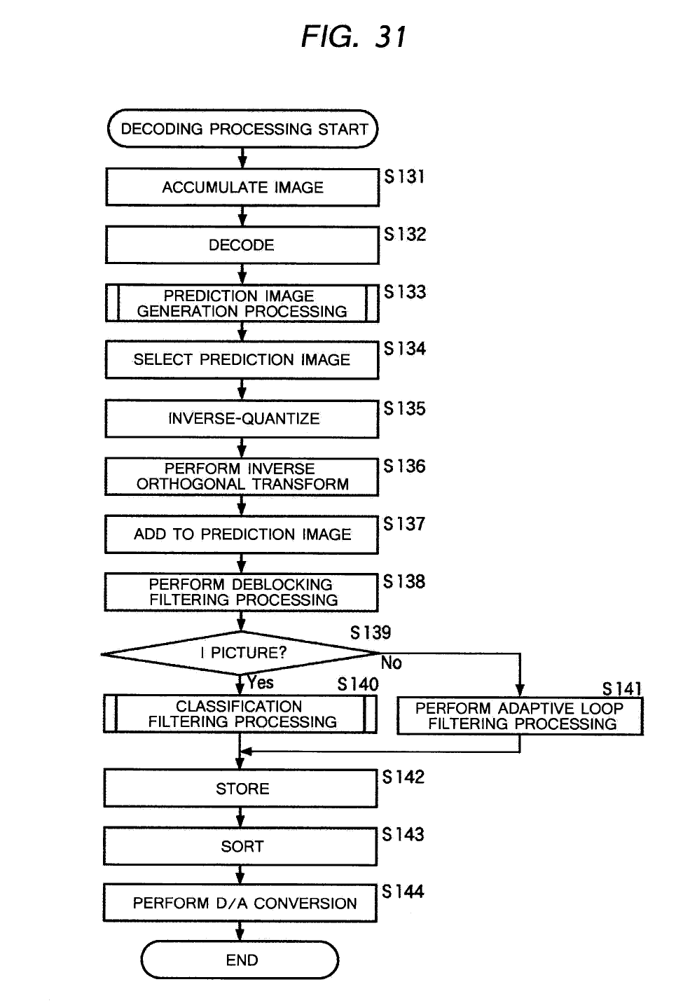

Description is given next of decoding processing to be executed by the image decoding apparatus 201 with reference to the flowchart of FIG. 31.

In step S131, the accumulation buffer 41 accumulates incoming images. In step S132, the lossless decoder 42 decodes compressed images to be supplied from the accumulation buffer 41. More specifically, I pictures, P pictures, and B pictures encoded by the lossless encoder 16 of FIG. 5 are decoded.

At this time, also decoded are information including motion vector information, reference frame information, prediction mode information (information indicating intra prediction modes or inter prediction modes), and adaptive filter coefficients for the classes.

Specifically, in the case where the prediction mode information is intra prediction mode information, the prediction mode information is supplied to the intra predictor 51. In the case where the prediction mode information is inter prediction mode information, the prediction mode information and the associated motion vector information and reference frame information are supplied to the motion compensator 52. The adaptive filter coefficients for the classes are decoded per slice or picture parameter set to be supplied to the adaptive loop filter 211.

In step S133, the intra predictor 51 or the motion compensator 52 perform prediction image generation processing according to the prediction mode information to be supplied from the lossless decoder 42.

Specifically, in the case where intra prediction mode information is supplied from the lossless decoder 42, the intra predictor 51 performs intra prediction processing in the intra prediction mode to generate intra prediction images. In the case where inter prediction mode information is supplied from the lossless decoder 42, the motion compensator 52 performs motion prediction/compensation processing in the inter prediction mode to generate inter prediction images.

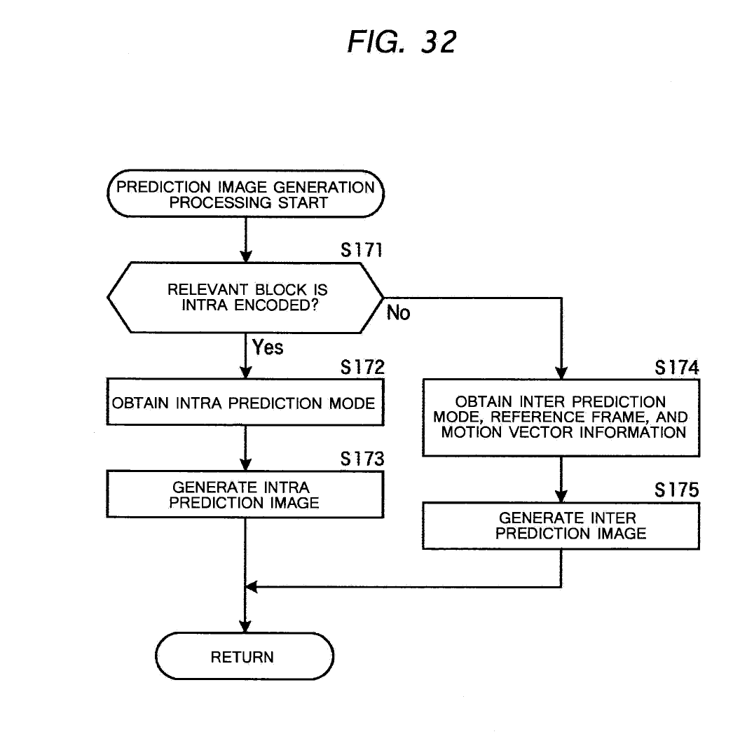

The prediction image generation processing in step S133 is described in detail later with reference to FIG. 32. Through this processing, the switch 53 is supplied with prediction images generated by the intra predictor 51 (intra prediction images) or prediction images generated by the motion compensator 52 (inter prediction images).

In step S134, the switch 53 selects prediction images. More specifically, supplied are prediction images generated by the intra predictor 51 or prediction images generated by the motion compensator 52. Hence, prediction images supplied are selected for supply to the arithmetic operator 45, so as to be added to the outputs of the inverse orthogonal transformer 44 in step S137 to be described later.

In the above-described step S132, transform coefficients decoded by the lossless decoder 42 are also supplied to the inverse quantizer 43. In step S135, the inverse quantizer 43 performs inverse quantization on the transform coefficients decoded by the lossless decoder 42 with characteristics corresponding to the characteristics of the quantizer 15 of FIG. 5.

In step S136, the inverse orthogonal transformer 44 performs an inverse orthogonal transform on the transform coefficients inverse-quantized by the inverse quantizer 43 with characteristics corresponding to the characteristics of the orthogonal transformer 14 of FIG. 5. Difference information corresponding to the inputs of the orthogonal transformer 14 of FIG. 5, i.e., the outputs of the arithmetic operator 13, is decoded by this processing.

In step S137, the arithmetic operator 45 adds to the difference information prediction images to be selected in the process of step S134 and to be input through the switch 53. Original images are decoded by this processing. In step S138, the deblocking filter 46 performs deblocking filtering processing on the images output from the arithmetic operator 45. Block distortion in the screen is generally removed by this processing.

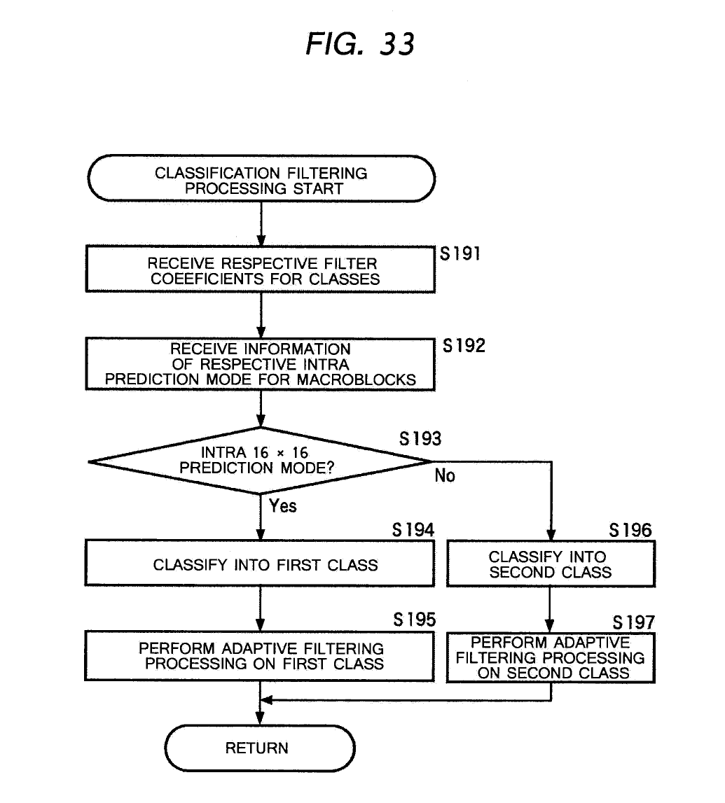

In step S139, the adaptive loop filter 211 determines whether the decoded image from the deblocking filter 21 is an I picture. In the case where an I picture is determined in step S139, the adaptive loop filter 111 performs classification filtering processing in step S140. The classification filtering processing is described in detail later with reference to FIG. 33. It is to be noted here that the adaptive loop filter 211 in this case is configured as depicted in FIG. 30.

Classification is conducted according to the intra prediction mode by the process of step S140, such that adaptive filtering processing is performed for the classes. The adaptive filtered pixel values are output to the screen sorting buffer 47 and the frame memory 49.

Meanwhile, in the case where an I picture is not determined in step S139, the processing proceeds to step S141. In step S141, the adaptive loop filter 211 uses one adaptive filter coefficient for the entire pixel values of the screen to perform adaptive filtering processing. The adaptive filter coefficients in this case are acquired by the lossless decoder 42 from slice headers or picture parameter sets for supply to the adaptive loop filter 211. The adaptive filtered pixel values are output to the screen sorting buffer 47 and the frame memory 49. It is to be noted here that illustration is not made of a detailed configuration example of the adaptive loop filter 211 in the case of a picture other than the I picture.

In step S142, the frame memory 49 retains the adaptive filtered images.

In step S143, the screen sorting buffer 47 sorts images past the adaptive loop filter 211. Specifically, the frame order that has been sorted by the screen sorting buffer 12 of the image coding apparatus 101 for encoding is sorted into the original display order.

In step S144, the D/A converter 48 performs D/A conversion on the images from the screen sorting buffer 47. These images are output to a display (not shown), and the images are displayed thereon.

### Description of Prediction Image Generation Processing of Image Decoding Apparatus

Description is given next of the prediction image generation processing in step S133 of FIG. 31 with reference to the flowchart of FIG. 32.

In step S171, the intra predictor 51 determines whether or not the target block is intra-encoded. When intra prediction mode information is supplied to the intra predictor 51 from the lossless decoder 42, the intra predictor 51 determines in step S171 that the target block is intra-encoded, and the processing proceeds to step S172. At this time, the intra predictor 51 supplies the intra prediction mode information to the prediction mode buffer 212.

The intra predictor 51 obtains in step S172 intra prediction mode information and performs intra prediction in step S173 to generate intra prediction images.

In the case where the images to be processed are images to be subjected to intra processing, images for use are read from the frame memory 49 and are supplied through the switch 50 to the intra predictor 51. In step S173, the intra predictor 51 performs intra prediction according to the intra prediction mode information obtained in step S172 to generate prediction images. The generated prediction images are output to the switch 53.

Meanwhile, in the case where it is determined in step S171 that intra encoding is not performed, the processing proceeds to step S174.

In the case where the images to be processed are images to be subjected to inter processing, inter prediction mode information, reference frame information, and motion vector information are supplied from the lossless decoder 42 to the motion compensator 52.

In step S174, the motion compensator 52 obtains information including prediction mode information output from the lossless decoder 42. Specifically, motion (inter) prediction mode information, reference frame information, and motion vector information are obtained.

In step S175, the motion compensator 52 uses motion vector information and performs compensation on reference images from the frame memory 49 to generate inter prediction images. The generated prediction images are supplied through the switch 53 to the arithmetic operator 45 and are added to the outputs from the inverse orthogonal transformer 44 in step S137 of FIG. 31.

### Description of Classification Filtering Processing of Image Decoding Apparatus

Description is given next of the classification filtering processing in step S140 of FIG. 31 with reference to the flowchart of FIG. 33.

The lossless decoder 42 supplies adaptive filter coefficients for the first class and the second class, which coefficients are available from picture parameter sets or slice headers, to the filter coefficient buffers 231-1 and the 231-2, respectively.

The filter coefficient buffer 231-1 accumulates the adaptive filter coefficients for the first class for supply to the filtering processor 233-1. The filter coefficient buffer 231-2 accumulates the adaptive filter coefficients for the second class for supply to the filtering processor 233-2.

In step S191, the filtering processors 233-1 and 233-2 receive the adaptive filter coefficients for the associated classes from the filter coefficient buffers 231-1 and 231-2, respectively.

Further, intra prediction mode information from the lossless decoder 42 on macroblocks is supplied through the intra predictor 51 and the prediction mode buffer 212 to the classifier 232.

In step S192, the classifier 232 receives intra prediction mode information containing information as to which of an intra 4×4, 8×8, or 16×16 prediction mode the macroblocks are encoded in.

In step S193, the classifier 232 references the received intra prediction mode information to determine whether or not the intra prediction mode(s) of the macroblocks is an intra 16×16 prediction mode. In the case where an intra 16×16 prediction mode is determined in step S193, the classifier 232 classifies the deblocking filtered pixel values to the first class in step S194. Specifically, the pixel value of a macroblock determined as being in an intra 16×16 prediction mode is classified to the first class defining the flat portion region class. The classifier 232 supplies the pixel values of the macroblocks classified in the first class to the filtering processor 233-1.

In step S195, the filtering processor 233-1 performs adaptive filtering processing for the first class. Specifically, the filtering processor 233-1 uses the adaptive filter coefficients from the filter coefficient buffer 231-1 for the first class to perform filtering processing on the pixel values of the macroblocks that have been classified by the classifier 232 to the first class. The adaptive filtered pixel values are supplied to the screen sorting buffer 47 and the frame memory 49.

In the case where an intra 16×16 prediction mode is not determined in step S193, the classifier 232 classifies the deblocking filtered pixel values to the second class in step S196. Specifically, the pixel values of the macroblocks that have been determined as being in an intra 8×8 or intra 4×4 prediction mode and not in an intra 16×16 prediction mode are classified to the second class defining the edge/texture region class. The classifier 232 supplies the pixel values of the macroblocks classified in the second class to the filtering processor 233-2.

In step S197, the filtering processor 233-2 performs adaptive filtering processing for the second class. Specifically, the filtering processor 233-2 uses the adaptive filter coefficients from the filter coefficient buffer 231-2 for the second class to perform filtering processing on the pixel values of the macroblocks that have been classified to the second class by the classifier 232. The adaptive filtered pixel values are supplied to the screen sorting buffer 47 and the frame memory 49.

As described above, in the image coding apparatus 101 and the image decoding apparatus 201, for the I picture, images of I pictures are classified to classes corresponding to intra prediction modes, so as to be applied with adaptive loop filtering processing per class.

This allows for minimization of image degradation in the screen as a whole and also for improvement in local image degradation that may occur either in flat portions or regions including, for example, texture in the screen, with the result of improvement in coding efficiency.

In the foregoing description, the encoding standard is based on H.264/AVC standard. The present invention is however not limited thereto and is applicable to other encoding standards/decoding standards that involve intra prediction modes for a plurality of block sizes and an adaptive filter within a motion prediction/compensation loop.

It is to be noted that the present invention is applicable to image coding apparatuses and image decoding apparatuses for use in receiving image information (bitstreams) that is compressed by means of an orthogonal transform, such as discrete cosine transform, and motion compensation, through network media, such as satellite broadcasting, cable television, the Internet, or mobile phones, according to, for example, MPEG and H.26×. Further, the present invention is applicable to image coding apparatuses and image decoding apparatuses for use in performing processing on storage media such as optical disks, magnetic disks, and flash memories. Moreover, the present invention is applicable to motion prediction/compensation apparatuses included in those image coding apparatuses and image decoding apparatuses.

The series of processes described above are executable either by hardware or software. In the case of executing the series of processes by software, programs configuring the software are installed on a computer. Herein, exemplary computers include computers that are built in dedicated hardware and general-purpose personal computers configured to execute various functions on installation of various programs.

### Configuration Example of Personal Computer

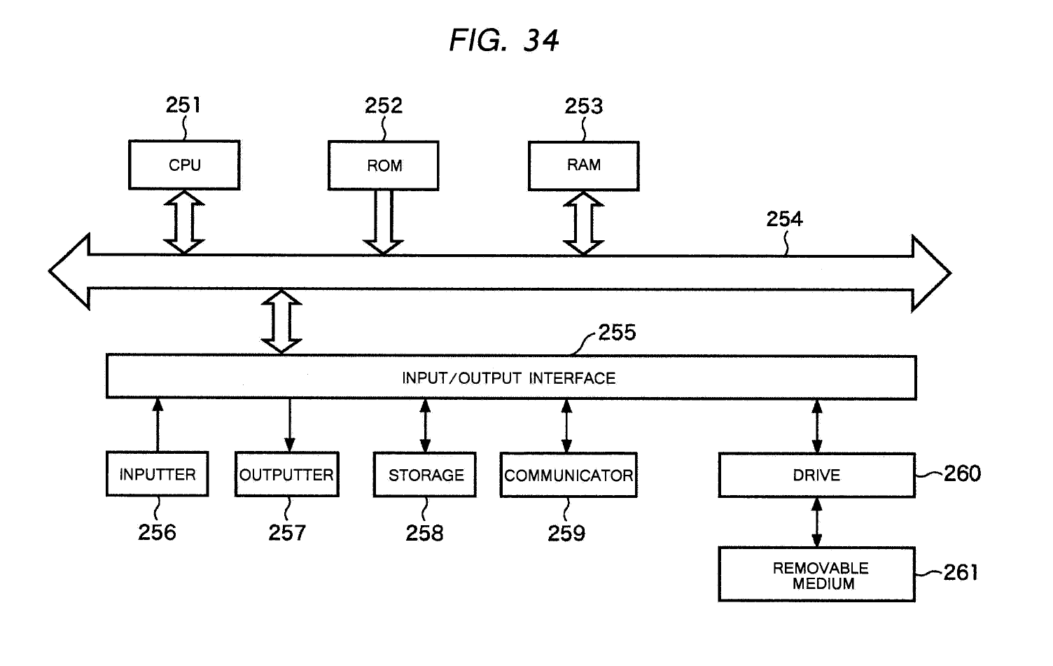

FIG. 34 is a block diagram depicting a configuration example of the hardware of a computer for executing the above-described series of processes based on a program.

In the computer, a CPU (Central Processing Unit) 251, a ROM (Read Only Memory) 252, and a RAM (Random Access Memory) 253 are coupled to one another by a bus 254.

The bus 254 is further connected with an input/output interface 255. To the input/output interface 255 are connected with an inputter 256, an outputter 257, a storage 258, a communicator 259, and a drive 260.

The inputter 256 includes a keyboard, a mouse, and a microphone. The outputter 257 includes a display and a speaker. The storage 258 includes a hard disk and a nonvolatile memory. The communicator 259 includes a network interface. The drive 260 drives a removable medium 261 such as a magnetic disk, an optical disk, a magnetoptical disk, or a semiconductor memory.

In the computer thus configured, the CPU 251 executes a program that is stored on, for example, the storage 258 by having the program loaded on the RAM 253 through the input/output interface 255 and the bus 254, such that the above-described series of processes is performed.

The program to be executed by the computer (CPU 251) may be provided in the form of the removable medium 261 as, for example, a package medium recording the program. The program may also be provided through a wired or radio transmission medium such as Local Area Network, the Internet, or digital broadcasting.

In the computer, the program may be installed on the storage 258 through the input/output interface 255 with the removable medium 261 attached to the drive 260. The program may also be received through a wired or radio transmission medium at the communicator 259 for installation on the storage 258. Otherwise, the program may be installed on the ROM 252 or the storage 258 in advance.

The program to be executed by the computer may be a program by which the processes are performed in time sequence according to the order described herein, or alternatively, may be a program by which processes are performed at an appropriate timing, e.g., in parallel or when a call is made.

Embodiments of the present invention are not limited to the foregoing embodiments, and various changes and modifications can be made without departing from the scope of the present invention.

For example, the above-described image coding apparatus 101 and the image decoding apparatus 201 are applicable to any electronics. Examples thereof are described hereinafter.

### Configuration Example of Television Receiver

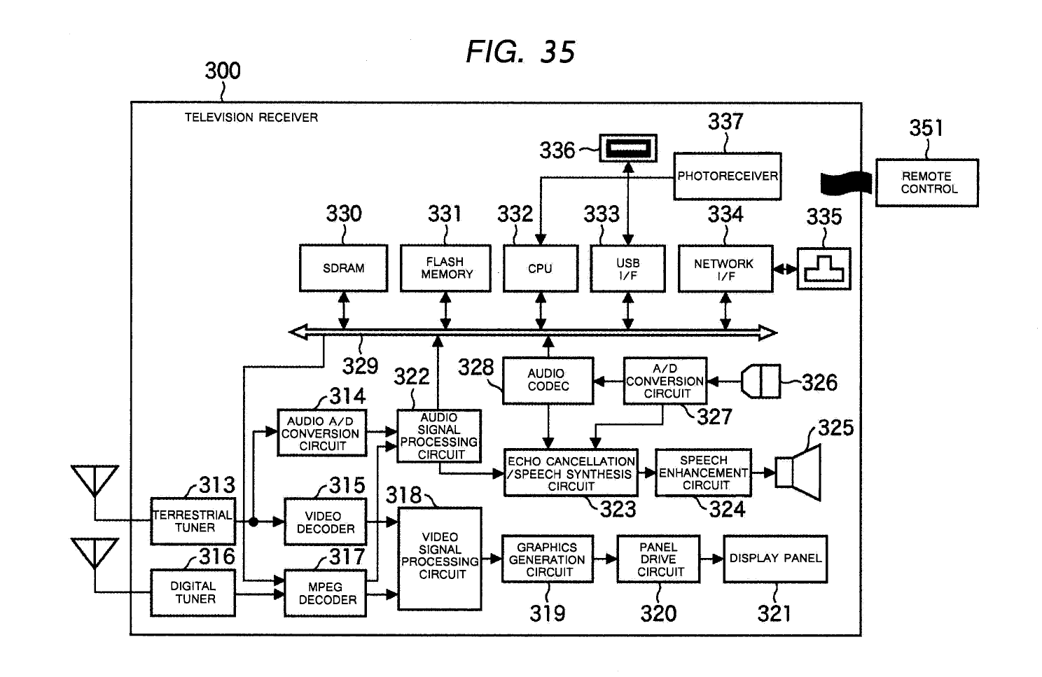

FIG. 35 is a block diagram depicting a main configuration example of a television receiver using an image decoding apparatus to which the present invention is applied.

A television receiver 300 depicted in FIG. 35 includes a terrestrial tuner 313, a video decoder 315, a video signal processing circuit 318, a graphics generation circuit 319, a panel drive circuit 320, and a display panel 321.

The terrestrial tuner 313 receives broadcast wave signals for terrestrial analog broadcasting through an antenna, demodulates them to obtain video signals, and supplies the signals to the video decoder 315. The video decoder 315 performs decoding processing on the video signals supplied from the terrestrial tuner 313 and supplies the resultant digital component signals to the video signal processing circuit 318.

The video signal processing circuit 318 performs predetermined processing such as noise reduction on the video data supplied from the video decoder 315 and supplies the resultant video data to the graphics generation circuit 319.

The graphics generation circuit 319 generates, for example, video data for broadcasts to be displayed on the display panel 321 and image data obtainable upon processing based on an application to be supplied over a network, so as to supply the generated video data and image data to the panel drive circuit 320. In addition, the graphics generation circuit 319 appropriately performs processing, such as generating video data (graphics) to be used for displaying a screen for use by a user upon selection of an item and supplying to the panel drive circuit 320 video data obtainable, for example, through superimposition on the video data of a broadcast.

The panel drive circuit 320 drives the display panel 321 based on the data supplied from the graphics generation circuit 319 and causes the display panel 321 to display thereon video of broadcasts and various screens as described above.

The display panel 321 includes an LCD (Liquid Crystal Display) and is configured to display video of broadcasts under the control of the panel drive circuit 320.

Further, the television receiver 300 also includes an audio A/D (Analog/Digital) conversion circuit 314, an audio signal processing circuit 322, an echo cancellation/speech synthesis circuit 323, a speech enhancement circuit 324, and a speaker 325.

The terrestrial tuner 313 demodulates the received broadcast wave signals so as to obtain not only video signals but also audio signals. The terrestrial tuner 313 supplies the obtained audio signals to the audio A/D conversion circuit 314.

The audio A/D conversion circuit 314 performs A/D conversion processing on the audio signals supplied from the terrestrial tuner 313 and supplies the resultant digital audio signals to the audio signal processing circuit 322.

The audio signal processing circuit 322 performs predetermined processing such as noise reduction on the audio data supplied from the audio A/D conversion circuit 314 and supplies the resultant audio data to the echo cancellation/speech synthesis circuit 323.

The echo cancellation/speech synthesis circuit 323 supplies the audio data supplied from the audio signal processing circuit 322 to the speech enhancement circuit 324.

The speech enhancement circuit 324 performs D/A conversion processing and amplification processing on the audio data supplied from the echo cancellation/speech synthesis circuit 323 and then makes adjustment to a specific sound volume, so as to cause the speaker 325 to output the audio.

Further, the television receiver 300 includes a digital tuner 316 and an MPEG decoder 317.

The digital tuner 316 receives broadcast wave signals for digital broadcasting (terrestrial digital broadcasting and BS (Broadcasting Satellite)/CS (Communications Satellite) digital broadcasting) through an antenna, demodulates the signals, and obtains MPEG-TSs (Moving Picture Experts Group-Transport Streams), for supply to the MPEG decoder 317.

The MPEG decoder 317 performs unscrambling on the MPEG-TSs supplied from the digital tuner 316, so as to extract a stream containing data of a broadcast to be played (viewed.) The MPEG decoder 317 decodes audio packets constructing the extracted stream and supplies the resultant audio data to the audio signal processing circuit 322, while decoding video packets constructing the stream to supply the resultant video data to the video signal processing circuit 318. Further, the MPEG decoder 317 supplies EPG (Electronic Program Guide) data extracted from the MPEG-TSs through a path (not shown) to the CPU 332.

The television receiver 300 thus uses the above-described image decoding apparatus 201 in the form of the MPEG decoder 317 for decoding video packets. Hence, the MPEG decoder 317 allows for, as in the case of the image decoding apparatus 201, minimization of image degradation in the screen as a whole as well as improvement in local image degradation.

The video data supplied from the MPEG decoder 317 is, as in the case of the video data supplied from the video decoder 315, is subjected to predetermined processing at the video signal processing circuit 318. Then, the video data performed with the predetermined processing is appropriately superimposed at the graphics generation circuit 319 with, for example, video data generated, and is supplied through the panel drive circuit 320 to the display panel 321, such that the images are displayed thereon.

The audio data supplied from the MPEG decoder 317 is, as in the case of the audio data supplied from the audio A/D conversion circuit 314, subjected to predetermined processing at the audio signal processing circuit 322. Then, the audio data performed with the predetermined processing is supplied through the echo cancellation/speech synthesis circuit 323 to the speech enhancement circuit 324 to be subjected to D/A conversion processing and amplification processing. As a result, audio adjusted to a specific sound volume is output from the speaker 325.

The television receiver 300 also includes a microphone 326 and an A/D conversion circuit 327.

The A/D conversion circuit 327 receives signals of speech of users to be taken by the microphone 326 that is provided in the television receiver 300 for use in speech conversation. The A/D conversion circuit 327 performs A/D conversion processing on the speech signals received and supplies the resultant digital speech data to the echo cancellation/speech synthesis circuit 323.

The echo cancellation/speech synthesis circuit 323 performs, in the case where speech data of a user (a user A) of the television receiver 300 is supplied from the A/D conversion circuit 327, echo cancellation on the speech data of the user A. Then, the echo cancellation/speech synthesis circuit 323 causes the speaker 325, through the speech enhancement circuit 324, to output the speech data that results from echo cancellation followed by, for example, synthesis with other speech data.

The television receiver 300 further includes an audio codec 328, an internal bus 329, an SDRAM (Synchronous Dynamic Random Access Memory) 330, a flash memory 331, a CPU 332, a USB (Universal Serial Bus) I/F 333, and a network I/F 334.

The A/D conversion circuit 327 receives signals of speech of users taken by the microphone 326 that is provided in the television receiver 300 for use in speech conversation. The A/D conversion circuit 327 performs A/D conversion processing on the speech signals received and supplies the resultant digital speech data to the audio codec 328.

The audio codec 328 converts the speech data supplied from the A/D conversion circuit 327 into data in a predetermined format for transmission via a network and supplies the data through the internal bus 329 to the network I/F 334.

The network I/F 334 is connected to a network by means of a cable attached to a network terminal 335. The network I/F 334 transmits the speech data supplied from the audio codec 328 to, for example, another apparatus to be connected to the network. Further, the network I/F 334 receives through the network terminal 335 speech data to be transmitted from, for example, another apparatus to be connected through the network, so as to supply the data through the internal bus 329 to the audio codec 328.

The audio codec 328 converts the speech data supplied from the network I/F 334 into data in a predetermined format and supplies the data to the echo cancellation/speech synthesis circuit 323.

The echo cancellation/speech synthesis circuit 323 performs echo cancellation on the speech data to be supplied from the audio codec 328 and causes, through the speech enhancement circuit 324, the speaker 325 to output the speech data that results from, for example, synthesis with other speech data.

The SDRAM 330 stores various kinds of data to be used by the CPU 332 for processing.

The flash memory 331 stores programs to be executed by the CPU 332. The programs stored on the flash memory 331 are read by the CPU 332 at a specific timing such as upon boot of the television receiver 300. The flash memory 331 also stores data including EPG data that has been obtained via digital broadcasting and data that has been obtained from a specific server over a network.

For example, stored on the flash memory 331 is MPEG-TSs containing content data obtained from a specific server over a network under the control of the CPU 332. The flash memory 331 supplies the MPEG-TSs through the internal bus 329 to the MPEG decoder 317, for example, under the control of the CPU 332.

The MPEG decoder 317 processes, as in the case of the MPEG-TSs supplied from the digital tuner 316, the MPEG-TSs. In this manner, the television receiver 300 is configured to receive content data including video, audio, and other information, over a network, to perform decoding by using the MPEG decoder 317, and to provide the video for display or the audio for output.

The television receiver 300 further includes a photoreceiver 337 for receiving infrared signals to be transmitted from a remote control 351.

The photoreceiver 337 receives infrared light from the remote control 351 and outputs to the CPU 332 control codes indicating the content of the user operation that has been obtained through demodulation.

The CPU 332 executes programs stored on the flash memory 331 and conducts control of the overall operation of the television receiver 300 according to, for example, the control codes to be supplied from the photoreceiver 337. The CPU 332 and the constituent portions of the television receiver 300 are connected through paths (not shown).

The USB I/F 333 performs data transmission/reception with an external instrument of the television receiver 300, the instrument to be connected by means of a USB cable attached to a USB terminal 336. The network I/F 334 is connected to a network by means of a cable attached to the network terminal 335 and is configured to perform transmission/reception of data other than audio data with various apparatuses to be connected to the network.

The television receiver 300 allows for improvement in coding efficiency by the use of the image decoding apparatus 201 in the form of the MPEG decoder 317. As a result, the television receiver 300 is capable of obtaining and rendering finer decoded images based on broadcast wave signals receivable through an antenna and content data obtainable over networks.

### Configuration Example of Mobile Phone

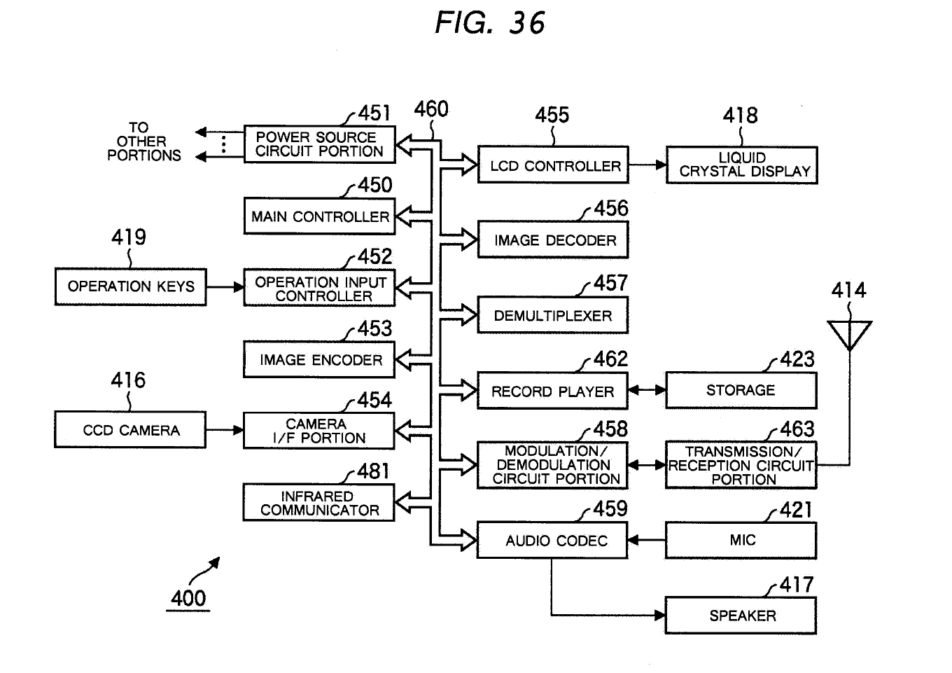

FIG. 36 is a block diagram depicting a main configuration example of a mobile phone using an image coding apparatus and an image decoding apparatus to which the present invention is applied.

A mobile phone 400 depicted in FIG. 36 includes a main controller 450 that is configured to perform overall control over the constituent portions, a power source circuit portion 451, an operation input controller 452, an image encoder 453, a camera I/F portion 454, an LCD controller 455, an image decoder 456, a demultiplexer 457, a record player 462, a modulation/demodulation circuit portion 458, and an audio codec 459. These portions are coupled to one another by a bus 460.

The mobile phone 400 also includes operation keys 419, a CCD (Charge Coupled Devices) camera 416, a liquid crystal display 418, a storage 423, a transmission/reception circuit portion 463, an antenna 414, a microphone (mic) 421, and a speaker 417.

The power source circuit portion 451 supplies power to the constituent portions from a battery pack when a call-end-and-power-on key is switched on by a user operation, so as to activate the mobile phone 400 into an operable condition.

The mobile phone 400 performs various operations including transmission/reception of speech signals, transmission/reception of emails and image data, image photographing, and data recording in various modes, such as a voice call mode and a data communication mode, under the control of the main controller 450 configured by, for example, a CPU, a ROM, and a RAM.

For example, in the voice call mode, the mobile phone 400 converts speech signals collected by the microphone (mic) 421 to digital speech data by the audio codec 459 and performs spread spectrum processing at the modulation/demodulation circuit portion 458, for digital/analog conversion processing and frequency conversion processing at the transmission/reception circuit portion 463. The mobile phone 400 transmits the transmitting signals obtained by the conversion processing, through the antenna 414 to a base station (not shown). The transmitting signals (speech signals) transmitted to the base station are supplied over a public telecommunication line to a mobile phone of a call recipient.

Also, for example, in the voice call mode, the mobile phone 400 amplifies at the transmission/reception circuit portion 463 the reception signals that have been received through the antenna 414, further performs frequency conversion processing and analog/digital conversion processing, performs spread spectrum processing at the modulation/demodulation circuit portion 458, and converts the signals to analog speech signals by the audio codec 459. The mobile phone 400 outputs from the speaker 417 the analog speech signals thus obtained through the conversion.

Further, for example, in the case of transmitting emails in the data communication mode, the mobile phone 400 receives, at the operation input controller 452, text data of an email that has been input through operation on the operation keys 419. The mobile phone 400 processes the text data at the main controller 450 so as to cause through LCD controller 455 the liquid crystal display 418 to display the data as images.

The mobile phone 400 also generates at the main controller 450 email data based on, for example, the text data and the user instruction received at the operation input controller 452. The mobile phone 400 performs spread spectrum processing on the email data at the modulation/demodulation circuit portion 458 and performs digital/analog conversion processing and frequency conversion processing at the transmission/reception circuit portion 463. The mobile phone 400 transmits the transmitting signals that result from the conversion processing, through the antenna 414 to a base station (not shown). The transmitting signals (emails) that have been transmitted to the base station are supplied to prescribed addresses, for example, over networks and through mail servers.

For example, in the case of receiving emails in the data communication mode, the mobile phone 400 receives through the antenna 414 at the transmission/reception circuit portion 463 signals that have been transmitted from the base station, amplifies the signals, and further performs frequency conversion processing and analog/digital conversion processing. The mobile phone 400 restores original email data through inverse spread spectrum processing at the modulation/demodulation circuit portion 458. The mobile phone 400 causes through the LCD controller 455 the liquid crystal display 418 to display the restored email data.

It is to be noted that the mobile phone 400 may cause through the record player 462 the storage 423 to record (store) the received email data.

The storage 423 is a rewritable storage medium in any form. The storage 423 may, for example, a semiconductor memory such as a RAM or a built-in flash memory, a hard disk, or a removable medium such as a magnetic disk, a magnetoptical disk, an optical disk, a USB memory, or a memory card. Apparently, other storage media may appropriately used.

Further, for example, in the case of transmitting image data in the data communication mode, the mobile phone 400 generates image data by photographing with the CCD camera 416. The CCD camera 416 has an optical device such as a lens and a diaphragm and a CCD serving as a photoelectric conversion device and is configured to photograph a subject, to convert the intensity of the received light to electrical signals, and to generate image data of an image of the subject. The image data is compressed and encoded through the camera I/F portion 454 at the image encoder 453 according to a predetermined coding standard such as MPEG-2 or MPEG-4, so as to convert the data into encoded image data.

The mobile phone 400 uses the above-described image coding apparatus 101 in the form of the image encoder 453 for performing such processing. Hence, the image encoder 453 achieves, as in the case of the image coding apparatus 101, minimization of image degradation in the screen as a whole as well as local image degradation.

The mobile phone 400 performs, at the audio codec 459, analog/digital conversion on the speech collected by the microphone (mic) 421 simultaneously with photographing by the CCD camera 416 and further performs encoding thereon.

The mobile phone 400 multiplexes at the demultiplexer 457 the encoded image data supplied from the image encoder 453 and the digital speech data supplied from the audio codec 459 according to a predetermined standard. The mobile phone 400 performs spread spectrum processing on the resultant multiplexed data at the modulation/demodulation circuit portion 458 and then subjects the data to digital/analog conversion processing and frequency conversion processing at the transmission/reception circuit portion 463. The mobile phone 400 transmits the transmitting signals that result from the conversion processing, through the antenna 414 to a base station (not shown.) The transmitting signals (image data) that have been transmitted to the base station are supplied to a call recipient over, for example, a network.

In the case where the image data is not transmitted, the mobile phone 400 may cause not through the image encoder 453 but through the LCD controller 455 the liquid crystal display 418 to display the image data generated at the CCD camera 416.

Further, for example, in the case of receiving data of dynamic picture files that are linked to, for example, a simplified website in the data communication mode, the mobile phone 400 receives at the transmission/reception circuit portion 463 through the antenna 414 signals transmitted from the base station, amplifies the signals, and further performs frequency conversion processing and analog/digital conversion processing. The mobile phone 400 performs inverse spread spectrum processing on the received signals at the modulation/demodulation circuit portion 458 to restore the original multiplexed data. The mobile phone 400 separates the multiplexed data at the demultiplexer 457 to split the data into encoded image data and speech data.

The mobile phone 400 decodes at the image decoder 456 the encoded image data according to a decoding standard corresponding to a predetermined coding standard such as MPEG-2 or MPEG-4 to generate the dynamic picture data to be replayed, and causes, through the LCD controller 455, the liquid crystal display 418 to display the data thereon. In this manner, for example, moving picture data contained in dynamic picture files linked to a simplified website is displayed on the liquid crystal display 418.

The mobile phone 400 uses the above-described image decoding apparatus 201 in the form of the image decoder 456 for performing such processing. Hence, the image decoder 456 achieves, as in the case of the image decoding apparatus 201, minimization of image degradation in the screen as a whole as well as improvement in local image degradation.

At this time, the mobile phone 400 converts digital audio data to analog audio signals at the audio codec 459 and causes the speaker 417 to output the signals at the same timing. Thus, for example, audio data contained in dynamic picture files that are linked to a simplified website is replayed.

It is to be noted that, as in the case of emails, the mobile phone 400 may cause through the record player 462 the storage 423 to record (store) the received data that is linked to, for example, simplified websites.

The mobile phone 400 may also analyze, at the main controller 450, binary codes that have been obtained at the CCD camera 416 by photographing and obtain the information that is recorded in the binary codes.

Further, the mobile phone 400 may perform infrared communication with an external device at an infrared communicator 481.

The mobile phone 400 uses the image coding apparatus 101 in the form of the image encoder 453, so that improvement in coding efficiency is achieved. As a result, the mobile phone 400 is capable of providing encoded data (image data) with favorable coding efficiency to other apparatuses.

And besides, the mobile phone 400 uses the image decoding apparatus 201 in the form of the image decoder 456, so that improvement in coding efficiency is achieved. As a result, the mobile phone 400 is capable of obtaining and displaying finer decoded images from, for example, dynamic picture files that are linked to simplified websites.

In the foregoing description, the mobile phone 400 uses the CCD camera 416; instead of the CCD camera 416, an image sensor using a CMOS (Complementary Metal Oxide Semiconductor) (CMOS image sensor) may also be used. In this case also, the mobile phone 400 is capable of, as in the case of using the CCD camera 416, photographing a subject and generating image data of the images of the subject.

In the foregoing description, the mobile phone 400 is exemplarily illustrated; however, the image coding apparatus 101 and the image decoding apparatus 201 are applicable as in the case of the mobile phone 400 to any apparatus that has a photographing function and/or communication function similar to those of the mobile phone 400, such as PDAs (Personal Digital Assistants), smart phones, UMPCs (Ultra Mobile Personal Computers), netbooks, and laptop personal computers.

### Configuration Example of Hard Disk Recorder

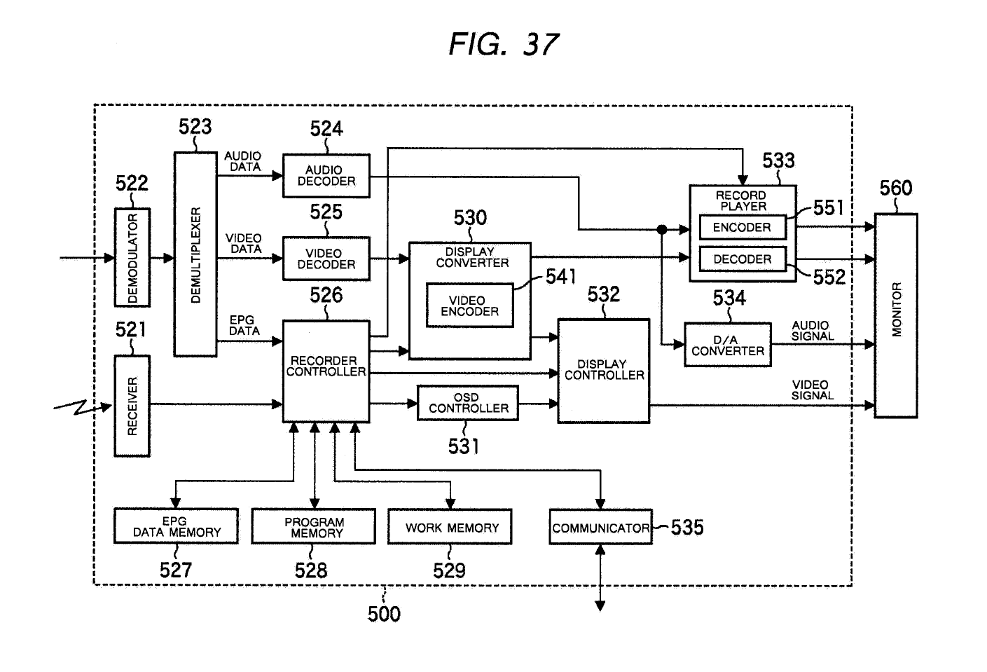

FIG. 37 is a block diagram depicting a main configuration example of a hard disk recorder using an image coding apparatus and an image decoding apparatus to which the present invention is applied.

A hard disk recorder (HDD recorder) 500 depicted in FIG. 37 is an apparatus for holding on a build-in hard disk audio data and video data of broadcasts contained in broadcast wave signals (television signals) to be transmitted from, for example, satellites or through terrestrial antennas and received from a tuner, so as to provide the held data to users at a timing in response to user instructions.

For example, the hard disk recorder 500 is configured to extract audio data and video data from broadcast wave signals and to decode the data suitably for storage on the built-in hard disk. The hard disk recorder 500 may also obtain audio data and video data from another apparatus over, for example, a network and decode the data suitably for storage on the built-in hard disk.

Further, for example, the hard disk recorder 500 is configured to decode audio data and/or video data that has been recorded on the built-in hard disk and to supply the decoded data to a monitor 560, so as to cause the monitor 560 to display the images on the screen thereof. In addition, the hard disk recorder 500 is configured to output the audio from a speaker of the monitor 560.

For example, the hard disk recorder 500 decodes audio data and video data extracted from broadcast wave signals obtained through a tuner, or audio data and video data obtained from another apparatus over a network and supplies the decoded data to the monitor 560, so as to cause the monitor 560 to display the images on the screen thereof. The hard disk recorder 500 may also cause a speaker of the monitor 560 to output the audio.

Apparently, other operations are also possible.

As depicted in FIG. 37, the hard disk recorder 500 includes a receiver 521, a demodulator 522, a demultiplexer 523, an audio decoder 524, a video decoder 525, and a recorder controller 526. The hard disk recorder 500 further includes an EPG data memory 527, a program memory 528, a work memory 529, a display converter 530, and an OSD (On Screen Display) controller 531, a display controller 532, a record player 533, a D/A converter 534, and a communicator 535.

In addition, the display converter 530 includes a video encoder 541. The record player 533 includes an encoder 551 and a decoder 552.

The receiver 521 receives infrared signals from a remote control (not shown) and converts the signals to electrical signals, so as to output the signals to the recorder controller 526. The recorder controller 526 is configured by, for example, a microprocessor and is configured to execute various processes according to programs stored on the program memory 528. At this time, the recorder controller 526 uses the work memory 529 when needed.

The communicator 535 is connected to a network to perform communication with another apparatus over the network. For example, the communicator 535 communicates, under the control of the recorder controller 526, with a tuner (not shown), so as to output channel selection control signals mainly to the tuner.

The demodulator 522 demodulates signals supplied from the tuner and outputs the signals to the demultiplexer 523. The demultiplexer 523 separates the data supplied from the demodulator 522 into audio data, video data, and EPG data and outputs the pieces of data to the audio decoder 524, the video decoder 525, and/or the recorder controller 526, respectively.

The audio decoder 524 decodes the input audio data according to, for example, an MPEG standard and outputs the data to the record player 533. The video decoder 525 decodes the input video data according to, for example, an MPEG standard and outputs the data to the display converter 530. The recorder controller 526 supplies the input EPG data to the EPG data memory 527 and to have the memory store the data.

The display converter 530 encodes video data supplied from the video decoder 525 or the recorder controller 526 by using the video encoder 541 into video data according to, for example, an NTSC (National Television Standards Committee) standard and outputs the data to the record player 533. The display converter 530 also converts the size of the screen of video data to be supplied from the video decoder 525 or the recorder controller 526 into a size corresponding to the size of the monitor 560. The display converter 530 converts the video data with converted screen size further to video data according to an NTSC standard by using the video encoder 541 and converts the data into analog signals, so as to output the signals to the display controller 532.

The display controller 532 superimposes, under the control of the recorder controller 526, OSD signals output from the OSD (On Screen Display) controller 531 on video signals input from the display converter 530, so as to output the signals to the display of the monitor 560 for display.

The monitor 560 is also configured to be supplied with audio data that has been output from the audio decoder 524 and then been converted by the D/A converter 534 to analog signals. The monitor 560 outputs the audio signals from a built-in speaker.

The record player 533 includes a hard disk as a storage medium for recording data including video data and audio data.

For example, the record player 533 encodes audio data to be supplied from the audio decoder 524 according to an MPEG standard by using the encoder 551. The record player 533 also encodes video data to be supplied from the video encoder 541 of the display converter 530 according to an MPEG standard by using the encoder 551. The record player 533 synthesizes the encoded data of the audio data and the encoded data of the video data by means of a multiplexer. The record player 533 subjects the synthesized data to channel coding for amplification and writes the data on the hard disk by using a record head.

The record player 533 replays the data recorded on the hard disk by using a playhead, amplifies the data, and separates the data into audio data and video data by means of a demultiplexer. The record player 533 decodes the audio data and the video data by using the decoder 552 according to an MPEG standard. The record player 533 performs D/A conversion on the decoded audio data and outputs the data to the speaker of the monitor 560. The record player 533 also performs D/A conversion on the decoded video data and outputs the data to the display of the monitor 560.

The recorder controller 526 reads the latest EPG data from the EPG data memory 527 in response to a user instruction that is indicated by infrared signals to be received through the receiver 521 from the remote control and supplies the data to the OSD controller 531. The OSD controller 531 generates image data corresponding to the input EPG data and outputs the data to the display controller 532. The display controller 532 outputs the video data input from the OSD controller 531 to the display of the monitor 560 for display. In this manner, an EPG (electronic program guide) is displayed on the display of the monitor 560.

The hard disk recorder 500 may also obtain various kinds of data, such as video data, audio data, or EPG data, to be supplied from other apparatuses over a network, such as the Internet.

The communicator 535 obtains the encoded data of, for example, video data, audio data, and EPG data to be transmitted from other apparatuses over a network under the control of the recorder controller 526 and supplies the data to the recorder controller 526. For example, the recorder controller 526 supplies the obtained encoded data of video data and audio data to the record player 533 to cause the hard disk to store the data thereon. At this time, the recorder controller 526 and the record player 533 may also perform processing such as transcoding as needed.

The recorder controller 526 decodes the obtained encoded data of video data and audio data and supplies the resultant video data to the display converter 530. The display converter 530 processes, in the same manner with respect to the video data to be supplied from the video decoder 525, the video data supplied from the recorder controller 526 and supplies the data through the display controller 532 to the monitor 560, so as to have the images displayed thereon.

Further, it may be so configured that, in addition to the image display, the recorder controller 526 supplies the decoded audio data through the D/A converter 534 to the monitor 560 and causes the audio to be output from the speaker.

Further, the recorder controller 526 decodes the obtained encoded data of EPG data, and supplies the decoded EPG data to the EPG data memory 527.

The hard disk recorder 500 as described above uses the image decoding apparatus 201 in the form of the video decoder 525, the decoder 552, and a decoder built in the recorder controller 526. Hence, the video decoder 525, the decoder 552, and the decoder built in the recorder controller 526 achieve, as in the case of the image decoding apparatus 201, minimization of image degradation in the screen as a whole and improvement in local image degradation.

Hence, the hard disk recorder 500 is capable of achieving high speed processing while generating more precise prediction images. As a result, the hard disk recorder 500 is capable of, for example, obtaining finer decoded images from the encoded data of video data received through a tuner, the encoded data of video data read from a hard disk of the record player 533, and the encoded data of video data obtained over a network, such that the images are displayed on the monitor 560.

Moreover, the hard disk recorder 500 uses the image coding apparatus 101 in the form of the encoder 551. Hence, the encoder 551 achieves, as in the case of the image coding apparatus 101, minimization of image degradation in the screen as a whole as well as improvement for local image degradation.

Hence, the hard disk recorder 500 allows for, for example, higher processing speed as well as improvement in coding efficiency of encoded data to be recorded on hard disks. As a result, the hard disk recorder 500 enables use of storage areas of hard disks at higher efficiency.

In the foregoing, description is given of a case of the hard disk recorder 500 for recording video data and audio data on a hard disk; however, the recording medium may obviously take any form. For example, the image coding apparatus 101 and the image decoding apparatus 201 are applicable to, as in the case of the above-described hard disk recorder 500, recorders using recording media other than hard disks, such as flash memories, optical disks, or video tapes.

### Configuration Example of Camera

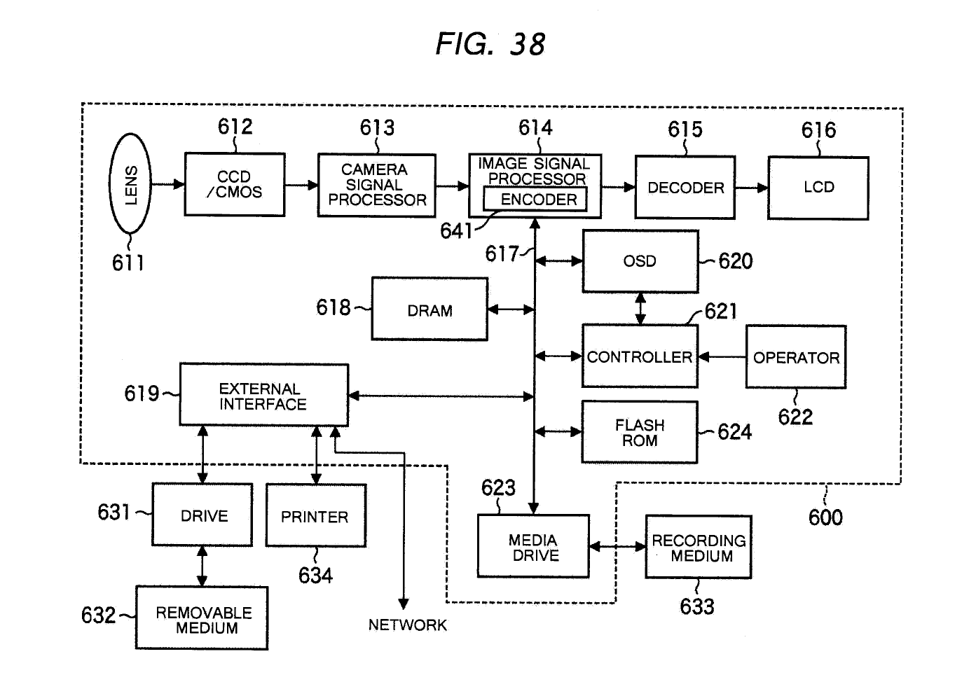

FIG. 38 is a block diagram depicting a main configuration example of a camera using an image decoding apparatus and an image coding apparatus to which the present invention is applied.

A camera 600 depicted in FIG. 38 is configured to photograph a subject, to cause the images of the subject to be displayed on an LCD 616, and to record the images on a recording medium 633 as image data.

A lens block 611 allows light, i.e., video of a subject, to be incident on a CCD/CMOS 612. The CCD/CMOS 612 is an image sensor using a CCD or a CMOS and is configured to convert the intensity of the received light into electrical signals and to supply the signals to a camera signal processor 613.

The camera signal processor 613 converts the electrical signals supplied from the CCD/CMOS 612 to color difference signals of Y, Cr, and Cb and supplies the signals to an image signal processor 614. The image signal processor 614 performs, under the control of a controller 621, prescribed image processing on the image signals supplied from the camera signal processor 613 and encodes the image signals according to, for example, an MPEG standard by means of an encoder 641. The image signal processor 614 supplies to a decoder 615 the encoded data generated by encoding the image signals. Further, the image signal processor 614 obtains displaying data generated at an on screen display (OSD) 620 and supplies the data to the decoder 615.

In the above-described processing, the camera signal processor 613 appropriately uses a DRAM (Dynamic Random Access Memory) 618 connected through a bus 617 and causes the DRAM 618 to retain image data and the encoded data obtained by encoding the image data, and other data, as needed.

The decoder 615 decodes the encoded data supplied from the image signal processor 614 and supplies the resultant image data (decoded image data) to the LCD 616. The decoder 615 also supplies displaying data supplied from the image signal processor 614 to the LCD 616. The LCD 616 suitably synthesizes the images of the decoded image data supplied from the decoder 615 with the images of the displaying data, so as to display the synthesized images.

The on screen display 620 outputs, under the control of the controller 621, displaying data for, for example, menu screens and icons including symbols, characters, or figures, through the bus 617 to the image signal processor 614.

The controller 621 executes various kinds of processing based on the signals indicating commands that the user gives by using an operator 622 and also executes control through the bus 617 over, for example, the image signal processor 614, the DRAM 618, an external interface 619, the onscreen display 620, and a media drive 623. Stored on the FLASH ROM 624 are, for example, programs and data to be used to enable the controller 621 to execute various kinds of processing.

For example, the controller 621 may, instead of the image signal processor 614 and the decoder 615, encode the image data stored on the DRAM 618 and decode the encoded data stored on the DRAM 618. In so doing, the controller 621 may perform encoding/decoding processing according to the same standard as the coding and decoding standard adopted by the image signal processor 614 and the decoder 615, or alternatively, may perform encoding/decoding processing according to a standard that is not supported by the image signal processor 614 and the decoder 615.

Further, for example, in the case where start of image printing is instructed by means of the operator 622, the controller 621 reads relevant image data from the DRAM 618 and supplies the data through the bus 617 to a printer 634 to be connected to the external interface 619 for printing.

Moreover, for example, in the case where image recording is instructed by means of the operator 622, the controller 621 reads relevant encoded data from the DRAM 618 and supplies for storage the data through the bus 617 to a recording medium 633 to be loaded to the media drive 623.

The recording medium 633 is a readable and writable removable medium such as a magnetic disk, a magnetoptical disk, an optical disk, or a semiconductor memory. The recording medium 633 may obviously of any types of removable media; for example, the recording medium 633 may be a tape device, a disk, or a memory card. Apparently, a non-contact IC card may also be included in the types.

Furthermore, the media drive 623 and the recording medium 633 may be integrated, so as to be configured into a non-portable recording medium such as a built-in hard disk drive or an SSD (Solid State Drive).

The external interface 619 may be configured, for example, by a USB Input/Output terminal and is to be connected to the printer 634 for printing images. A drive 631 is to be connected to the external interface 619 as needed, to be appropriately loaded with a removable medium 632 such as a magnetic disk, an optical disk, or a magnetoptical disk, such that computer programs read therefrom are installed on the FLASH ROM 624 as needed.

The external interface 619 further includes a network interface to be connected to a prescribed network such as a LAN or the Internet. For example, the controller 621 is configured to read, in response to an instruction from the operator 622, encoded data from the DRAM 618, so as to supply the data through the external interface 619 to another apparatus to be connected thereto via the network. The controller 621 may also obtain encoded data and image data to be supplied from another apparatus over the network through the external interface 619, so as to cause the DRAM 618 to retain the data or to supply the data to the image signal processor 614.

The above-described camera 600 uses the image decoding apparatus 201 in the form of the decoder 615. Hence, the decoder 615 achieves, as in the case of the image decoding apparatus 201, minimization of image degradation in the screen as a whole as well as improvement in local image degradation.

Hence, the camera 600 is capable of generating more precise prediction images. As a result, the camera 600 is capable of obtaining finer decoded images at a higher speed from, for example, image data generated at the CCD/CMOS 612, the encoded data of video data read from the DRAM 618 or the recording medium 633, and the encoded data of video data obtained over networks, for display on the LCD 616.

The camera 600 uses the image coding apparatus 101 in the form of the encoder 641. Hence, the encoder 641 achieves, as in the case of the image coding apparatus 101, minimization of image degradation in the screen as a whole as well as improvement in local image degradation.

Accordingly, the camera 600 achieves improvement in coding efficiency of encoded data to be recorded, for example, on hard disks. As a result, the camera 600 is allowed for use of storage areas in the DRAM 618 and the recording medium 633 at a higher rate and efficiency.

It is to be noted that a decoding method of the image decoding apparatus 201 is applicable to the decoding processing to be performed by the controller 621. Likewise, an encoding method of the image coding apparatus 101 is applicable to the encoding processing to be performed by the controller 621.

Further, image data to be photographed by the camera 600 may be either moving images or still images.

Apparently, the image coding apparatus 101 and the image decoding apparatus 201 are applicable to apparatuses and systems other than those described above.

### REFERENCE SIGNS LIST

16 Lossless encoder
21 Deblocking filter
24 Intra predictor
42 Lossless decoder
46 Deblocking filter
51 Intra predictor
101 Image coding apparatus
111 Adaptive loop filter
112 Prediction mode buffer
131 Classifier
132-1, 132-2 Filter coefficient calculator
133-1, 133-2 Filtering processor
201 Image decoding apparatus
211 Adaptive loop filter
212 Prediction mode buffer
231-1, 231-2 Filter coefficient buffer
232 Classifier
233-1, 233-2 Filtering processor

1. An image processing apparatus, comprising:
a classifier configured to classify an image per specific block according to intra prediction mode information; and
a filtering processor configured to perform filtering processing on the specific blocks to be classified by the classifier, by use of a filter coefficient to be calculated based on the specific blocks to be classified to the same class.

2. The image processing apparatus according to claim 1, wherein the classifier is configured to classify an image per the block according to a prediction block size for the blocks in the intra prediction mode information.

3. The image processing apparatus according to claim 2, wherein the classifier is configured to classify an image per the block according to a block size, the block size being the prediction block size for the blocks and defined by a coding standard.

4. The image processing apparatus according to claim 3, wherein the classifier is configured to classify the blocks to be encoded in an intra 16×16 prediction mode as blocks included in a flat region.

5. The image processing apparatus according to claims 3, wherein the classifier is configured to classify the blocks to be encoded in an intra prediction mode that has a smaller block size than the intra 16×16 prediction mode as blocks including an edge or texture.

6. The image processing apparatus according to claim 3, wherein the classifier is configured to classify the blocks to be encoded in an intra prediction mode that has a larger block size than the intra 16×16 prediction mode as blocks included in a flat region.

7. The image processing apparatus according to claim 1, wherein
the specific blocks include a plurality of subblocks, and
the classifier is configured to classify an image per the block or per the subblock according to a kind of prediction modes for the blocks or the subblocks of the same prediction block size in the intra-related prediction mode information.

8. The image processing apparatus according to claim 7, wherein the classifier is configured to classify the blocks or the subblocks to be encoded in a vertical prediction mode and a horizontal prediction mode as the blocks or the subblocks including an edge or texture.

9. The image processing apparatus according to claim 7, wherein the classifier is configured to classify the blocks or subblocks to be encoded in a prediction mode other than a vertical prediction mode and a horizontal prediction mode as the blocks or the subblocks included in a flat region.

10. The image processing apparatus according to claim 1, further comprising:
a filter coefficient calculator configured to calculate the filter coefficient based on the specific blocks to be classified to the same class.

11. The image processing apparatus according to claim 10, further comprising:
a transmitter configured to transmit bitstreams of the image, information indicating the intra prediction-related modes, and the filter coefficient to be calculated by the filter coefficient calculator.

12. The image processing apparatus according to claim 1, further comprising:
a receiver configured to receive bitstreams of the image, information indicating the intra prediction-related modes, and the filter coefficient.

13. A method of processing images for use in an image processing apparatus including a classifier and a filtering processor, the method comprising:
classifying by the classifier an image per specific block according to intra prediction mode information; and
performing by the filtering processor filtering processing on the classified specific blocks by using a filter coefficient calculated based on the specific blocks classified to the same class.
